(19) United States
(12) Patent Application Publication
(10) Pub. No.: US 2026/0043502 A1
(43) Pub. Date: Feb. 12, 2026

(54) ANTI-ROTATION APPARATUS AND METHOD AND A PIPE ASSEMBLY AND A SYSTEM HAVING SAME

(71) Applicant: Westlake Pipe & Fittings Corporation, Houston, TX (US)

(72) Inventors: George Ferguson, Wayne, PA (US); Joshua E. Clapper, Downingtown, PA (US); Thomas Soper, Wayne, PA (US); Roy L. Dean, Schwenksville, PA (US); Dmitry Yashin, Haverford, PA (US); Andrew Wells, Wayne, PA (US); Austin Bragg, Wayne, PA (US); Andrew Schlosser, Wayne, PA (US); Harrison Connors, Wayne, PA (US); Jake Hostrander, Wayne, PA (US)

(21) Appl. No.: 19/298,051

(22) Filed: Aug. 12, 2025

Related U.S. Application Data
(60) Provisional application No. 63/682,036, filed on Aug. 12, 2024.
(60) Provisional application No. 63/682,042, filed on Aug. 12, 2024.

(51) Int. Cl. F16L 21/08; E21B 17/046

(52) U.S. Cl. CPC F16L 21/08; E21B 17/0465

(57) ABSTRACT

An anti-rotation apparatus for a pipe joint includes: a stop piece having a body with a retaining portion and a locking part; a first joint part and a second joint part coupled to one another and having an axis in a lengthwise direction of the pipe joint; a locking receptacle provided in the first joint part; and a receiving receptacle provided in the second joint part. The retaining portion of the body of the stop piece is retained in the receiving receptacle of the second joint part and the locking part protrudes in a direction of the locking receptacle. When the locking part and the locking receptacle are rotationally aligned and the locking part is disposed in the locking receptacle of the first joint part, relative rotation about the axis between the first joint part and the second joint part is prevented.

### RELATED APPLICATION DATA

This patent is entitled to the benefit of and claims priority to co-pending U.S. Provisional Application Ser. Nos. 63/682,036 and 63/682,042, each filed Aug. 12, 2024, and each entitled “Anti-Rotation Apparatus and Method and a Pipe Assembly and a System Having Same.” The entire contents of these prior filed application are hereby incorporated herein by reference.

### BACKGROUND

### 1. Field of the Disclosure

The present disclosure is generally directed to pipe joints, and more particularly to an anti-rotation feature for a joint connecting pipe sections along a string of pipe.

### 2. Description of Related Art

Pipe formed from plastic material has become common for use in private residences, commercial facilities, and municipalities. Plastic pipe is often made from poly-vinyl chloride (PVC). Pipe sections are joined together at pipe joints to form extended lengths or a string of pipe for myriad uses. The pipe joints in some instances are fixed whereby the pipe sections and the pipe joints are plastic welded or permanently bonded together. However, in many installations and uses, the pipe sections are connected to one another using pipe joints whereby the pipes and joints are separable and/or movable relative to one another.

A typical pipe connection at a pipe joint in these types of pipe systems allows for some axial movement and rotation among the pipe sections and the pipe joints. In some applications, this is acceptable or even desired, particularly for pipe systems whereby the components are completely static. However, rotation among the pipe system components can be unfavorable or problematic for a large variety of piping applications, particularly where rotational forces may be applied to the string of pipe.

A primary example of such a system is known as a drop pipe system. A drop pipe system may extend down into the ground below the water table for pumping water to the surface. A pump is installed and connected at or near the bottom of the string of pipe. A power line or cable is run along the length of the pipe from a power source above ground down to the pump. During operation, the pump exerts a rotational force, i.e., torque to the pipe and can spin the pipe joints and/or the pipe sections relative to one another along the string of pipe. Over time, this can result in the power cable to the pump wrapping around the pipe and eventually disconnecting or splitting. Power loss to the pump will result once the cable is disconnected or splits or breaks.

### SUMMARY

In one embodiment according to the teachings of the present disclosure, an anti-rotation apparatus for a pipe joint includes: a stop piece having a body with a retaining portion and a locking part; a first joint part and a second joint part coupled to one another and having an axis in a lengthwise direction of the pipe joint; a locking receptacle provided in the first joint part; and a receiving receptacle provided in the second joint part. The retaining portion of the body of the stop piece is retained in the receiving receptacle of the second joint part and the locking part protrudes in a direction of the locking receptacle. When the locking part and the locking receptacle are rotationally aligned and the locking part is disposed in the locking receptacle of the first joint part, relative rotation about the axis between the first joint part and the second joint part is prevented.

In one embodiment, the first joint part can be a spigot end of a first pipe, the second joint part can be a belled end of a second pipe, the spigot end can be disposed in the belled end, and the axis can be a center axis of the first and second pipes.

In one embodiment, the receiving receptacle can be a hole, a slot, or a keyhole through a wall of the second joint part.

In one embodiment, the receiving receptacle can be a threaded hole through a wall of the second joint part. The stop piece can include a threaded stem configured to be screwed into the threaded hole and a free end of the threaded stem can seat in the locking receptacle.

In one embodiment, the receiving receptacle can include a series of three threaded holes spaced apart circumferentially around the second joint part.

In one embodiment, the locking receptacle can include one or more locking grooves in an outer wall of the first joint part.

In one embodiment, the locking receptacle can include a plurality of locking grooves, each having a finite length and extending in a circumferential direction around the first joint part. The finite length and a spacing between the plurality of locking grooves can be configured so that one of the plurality of locking grooves is always in rotational alignment with the receiving receptacle and the stop piece.

In one embodiment, the body of the stop piece can include a head, stem protruding from the head, and mechanical threads formed on at least part of the stem. A free end of the stem opposite the head can define the locking part.

In one embodiment, the locking part can be installed in a radial direction relative to the axis from outside of the second joint part.

In one embodiment, the body of the stop piece can include a head, a stem protruding from the head, and a key disposed at a free end of the stem opposite the head. The key can include two bosses protruding in opposite directions from the free end of the stem and the key can define all or part of the locking part.

In one embodiment, the body of the stop piece can include an elbow, a pair of legs extending from the elbow at an acute angle relative to one another, and a foot at a free end of each of the pair of legs. Each foot can protrude outward away from the other foot. The legs can be resiliently bent toward one another and the feet, and the free ends of the legs can define the locking part.

In one embodiment according to the teachings of the present disclosure, a method is disclosed for forming a pipe joint having an anti-rotation feature and an axis. The method includes providing a first joint part having one or more locking receptacles formed in the first joint part and inserting the first joint part into a second joint part. When no retaining receptacle on the second joint part is yet circumferentially aligned with any of the one or more locking receptacles, the method includes rotating the first joint part and the second joint part relative to one another until a retaining receptacle on the second joint part is circumferentially aligned with one of the one or more locking parts. The method also includes moving the stop piece so that the locking part engages the one of the locking receptacles, thereby preventing relative rotation about the axis between the first joint part and the second joint part.

In one embodiment, the method can include partially inserting the stop piece into the retaining receptacle before the step of inserting the first joint part.

In one embodiment, the step of moving the stop piece can include installing the stop piece in the retaining receptacle.

In one embodiment according to the teachings of the present disclosure, a pipe joint assembly includes: a first pipe having a first pipe first end and a first pipe second end, the first pipe first end defining a spigot end of the first pipe; a second pipe having a second pipe first end and a second pipe second end, the second pipe second end defining a belled end of the second pipe, and the spigot end of the first pipe being inserted into the belled end of the second pipe; and an anti-rotation apparatus configured to prevent relative rotation between the first pipe and the second pipe. The anti-rotation apparatus includes a stop piece installed in a radial direction through a wall of the belled end of the second pipe. A locking part of the stop piece is received in a locking receptacle in an outer surface of a wall of the spigot end of the first pipe.

In one embodiment, the stop piece can be installed through a hole, a keyhole, or a slot in the wall of the belled end of the second pipe.

In one embodiment, the locking receptacle can be a circular locking recess or a locking groove formed in the outer surface of the first pipe.

In one embodiment according to the teachings of the present disclosure, a drop pipe system includes: a pump configured to be installed below ground; at least one power cord configured to extend from above ground level to the pump below ground level and to deliver power for operating the pump; a pipe string including a plurality of pipes, the pipe string having one end connected to the pump and another end accessible near ground level; a first pipe of the plurality of pipes having a first pipe first end and a first pipe second end; a second pipe of the plurality of pipes having a second pipe first end and a second pipe second end, the first pipe first end connected to the second pipe second end to form a pipe joint; and an anti-rotation apparatus at the pipe joint configured to prevent relative rotation between the first pipe and the second pipe when the pump is operated. The anti-rotation apparatus includes a stop piece installed in a radial direction through a wall the pipe joint. A locking part of the stop piece is received in a locking receptacle in an outer surface of another wall of the pipe joint.

In one embodiment, the first pipe first end is a spigot end, the second pipe second end is a belled end, and the spigot end of the first pipe is directly received within the belled end of the second pipe.

### BRIEF DESCRIPTION OF THE DRAWINGS

The drawings provided herewith illustrate examples or embodiments of the disclosure and therefore should not be considered as limiting the scope of the disclosure. There may be other examples and embodiments that may be equally effective to achieve the objectives and that may fall within the scope of the disclosure. Objects, features, and advantages of the present disclosure should become apparent to those having ordinary skill in the art upon reading the following description in conjunction with the drawing figures, in which:

FIG. 1 shows a generic schematic view of a drop pipe system for which the anti-rotation aspects of the present disclosure are well suited.

FIG. 2 shows an exploded perspective view of one embodiment of a pipe joint assembly with an anti-rotation apparatus according to the teachings of the present disclosure.

FIG. 3 shows a partially exploded perspective view of the pipe joint assembly of FIG. 1 and prior to assembly of the joint.

FIG. 4 shows a lengthwise perspective view and partial cross section of the pipe joint assembly of FIG. 3.

FIGS. 5A and 5B show various views of one embodiment of an anti-rotation stop or insert piece according to the teachings of the present disclosure and for the pipe joint assembly of FIGS. 2-4.

FIG. 6 shows a cross-section of a belled end of a first pipe of the pipe joint assembly of FIG. 2.

FIG. 7 shows the pipe joint assembly of FIG. 6 but during assembly of the joint.

FIG. 8A shows a plan view of the assembled pipes of FIG. 7 but without showing a stop piece of the anti-rotation apparatus.

FIG. 8B shows a partial cut-away view of the assembled pipes of FIG. 8A.

FIGS. 9A-10F show various plan views and partial cut-away views of the assembled pipes of FIGS. 8A and 8B and with the pipes in different rotational positions relative to one another according to the teachings of the present disclosure.

FIG. 11 shows the pipe joint assembly of FIG. 7 but with the joint fully assembled.

FIG. 12 shows a perspective view, partially cut away, of the pipe joint assembly of FIG. 11 according to the teachings of the present disclosure.

FIG. 13 shows an exploded perspective view of another embodiment of a pipe joint assembly according to the teachings of the present disclosure and with the ani-rotation stop or insert piece of FIGS. 5A and 5B.

FIG. 14 shows a perspective view of the pipe joint assembly of FIG. 13 but fully assembled.

FIG. 15 shows an exploded perspective view of another embodiment of a pipe joint assembly with an anti-rotation apparatus according to the teachings of the present disclosure.

FIG. 16 shows a partially exploded perspective view of the pipe joint assembly of FIG. 15 and prior to assembly of the joint.

FIG. 17 shows a lengthwise perspective view and partial cross section of the pipe joint assembly of FIG. 16.

FIGS. 18A-18C show various views of one embodiment of an anti-rotation stop or insert piece according to the teachings of the present disclosure and for the pipe joint assembly of FIGS. 15-17.

FIG. 19 shows a cross-section of the unassembled pipe joint assembly of FIG. 16.

FIG. 20 shows the pipe joint assembly of FIG. 19 with the pipe joint during assembly.

FIG. 21 shows the pipe joint assembly of FIG. 20 with the joint fully assembled but the anti-rotation apparatus unlocked.

FIG. 22 shows a perspective view, partially cut away, of the pipe joint assembly of FIG. 21 according to the teachings of the present disclosure.

FIG. 23 shows the pipe joint assembly of FIG. 21 but with the joint fully assembled and the anti-rotation apparatus locked.

FIG. 24 shows a perspective view, partially cut away, of the pipe joint assembly of FIG. 23 according to the teachings of the present disclosure.

FIG. 25 shows an exploded perspective view of another embodiment of a pipe joint assembly according to the teachings of the present disclosure and with the ani-rotation stop or insert piece of FIGS. 18A-18C.

FIG. 26 shows a perspective view of the pipe joint assembly of FIG. 23 but fully assembled.

FIG. 27 shows an exploded perspective view of another embodiment of a pipe joint assembly with an anti-rotation apparatus according to the teachings of the present disclosure.

FIG. 28 shows a partially exploded perspective view of the pipe joint assembly of FIG. 27 and prior to assembly of the joint.

FIG. 29 shows a lengthwise perspective view and partial cross section of the pipe joint assembly of FIG. 28.

FIGS. 30A-30D show various views of one embodiment of an anti-rotation stop or insert piece according to the teachings of the present disclosure and for the pipe joint assembly of FIGS. 27-29.

FIG. 31 shows a cross-section of the unassembled pipe joint assembly of FIG. 28.

FIG. 32 shows the pipe joint assembly of FIG. 31 with the pipe joint during assembly.

FIG. 33A shows a plan view of the assembled pipes of FIG. 32 but without showing a stop piece of the anti-rotation apparatus.

FIG. 33B shows a partial cut-away view of the assembled pipes of FIG. 33A.

FIG. 34 shows the pipe joint assembly of FIG. 32 with the joint fully assembled but the anti-rotation apparatus partly inserted and unlocked.

FIG. 35 shows the pipe joint assembly of FIG. 34 with the joint fully assembled and with the anti-rotation apparatus inserted but unlocked.

FIG. 36 shows the pipe joint assembly of FIG. 35 with the joint fully assembled and the anti-rotation apparatus locked.

FIG. 37 shows a perspective view, partially cut away, of the pipe joint assembly of FIG. 36 according to the teachings of the present disclosure.

FIG. 38 shows an exploded perspective view of another embodiment of a pipe joint assembly according to the teachings of the present disclosure and with the ani-rotation stop or insert piece of FIGS. 30A-30D.

FIG. 39 shows a perspective view of the pipe joint assembly of FIG. 38 but fully assembled.

FIGS. 40-42 show perspective views of yet another embodiment of a pipe joint assembly with an anti-rotation apparatus according to the teachings of the present disclosure.

FIGS. 43-45 show perspective views of yet another embodiment of a pipe joint assembly with an anti-rotation apparatus according to the teachings of the present disclosure.

The use of the same reference numbers or characters throughout the written description and drawings indicates similar or identical components, aspects, and features of the disclosure.

### DETAILED DESCRIPTION OF THE DISCLOSURE

An aspect of the present disclosure is to solve or improve upon one or more of the above-noted problems with prior known pipes and pipe joints. According to the embodiments of the present disclosure, a separate component, device, feature, or the like, i.e., the anti-rotation stop or insert piece is incorporated in a pipe joint. In some of the disclosed embodiments, the insert or stop piece is incorporated in a female end, i.e., in a belled end of a pipe or a coupler in a pipe coupling or pipe joint. In other disclosed embodiments, the insert or stop piece may be incorporated into a male or spigot end of a pipe or coupler in a pipe coupling or pipe joint. The insert or stop piece is added to the joint parts in a manner to allow for insertion of a male end, i.e., a spigot end, of a pipe or a coupler into a female end of another pipe or a coupler of the pipe joint.

In the disclosed embodiments, either in the correct rotational orientation or during initial allowable rotation of the pipe, the insert or stop piece is configured to engage with one or multiple features on a pipe that is joined to the pipe carrying the stop piece in order to prevent further rotation. The disclosed solutions function independently of features of the pipe that counteract tension in the pipe joint, allowing for disassembly of the pipe joint as desired. In many of the disclosed embodiments, the stop piece is inserted manually after the two joint parts are joined. For each of the disclosed embodiments, the size and shape of the insert or stop piece may be varied based on torque requirements and/or other aspects of a given application.

The specification does not necessarily describe all elements of various embodiments of the present disclosure. Descriptions of elements or components well-known in the art to which the present disclosure pertains or overlapping or repetitive descriptions have been entirely or partly omitted.

It should be understood that, when an element is referred to as being “connected” to another element, it can be directly or indirectly connected to the other element. An indirect connection includes one or more intervening elements or parts among or between two connected elements.

It should be understood that the terms “include,” “comprise,” “have,” and the like, and variations thereof, when used in the present disclosure, specify the presence of stated features, integers, steps, operations, elements, and/or components. The terms do not preclude the presence or addition of one or more other features, integers, steps, operations, elements, components, and/or groups thereof.

It should be understood that, where it is stated in the present disclosure that an element is located “on” another element, the element may be in direct contact with the other element, or another element may yet be present between the one element “on” the other element.

It should be understood that, although the terms first, second, etc., and other such similar terms may be used herein to describe various elements, these elements should not be limited by these terms. These types of terms are used merely to distinguish among various elements, unless expressly stated to the contrary. Similarly, terms such as “up,” “upward,” “vertical,” “down,” “downward,” “forward,” “rearward,” “horizontal,” “lateral,” and the like, if used herein, are used for reference as relative directional terms. It should be understood that these types of terms are also not strictly limiting, unless expressly stated herein.

It should be understood that the use of singular forms is intended to include the plural forms as well unless the context clearly dictates otherwise. Further, when a component, device, element, or the like of the present disclosure is described as having a purpose or performing an operation, function, or the like, the component, device, or element should be considered herein as being “configured to” meet that purpose or perform that operation or function.

Reference numerals, which may be used for method steps, are used for convenience of explanation, but not to limit an order of the steps. Thus, unless the context clearly dictates otherwise, the written order may be practiced otherwise.

Hereinafter, an operation principle and embodiments of the present disclosure are described in detail with reference to the accompanying drawings. In each embodiment, the pipe joint assembly includes a coupling or pipe joint that joins and interlocks two pipes or pipe sections to one another. Though not described in detail herein, the coupling or pipe joint may include a separate coupler that connects two pipes together and each connection between a pipe and the coupler may be configured as described herein. However, in the disclosed embodiments, each coupling or joint is a direct connection between two adjacent pipes or pipe sections. Aspects of the present disclosure and the embodiments described herein are described as being suitable for use in a drop pipe system. However, as should be apparent to those having ordinary skill in the art, the ani-rotation concepts can be used for other pipe joints and pipe systems as well.

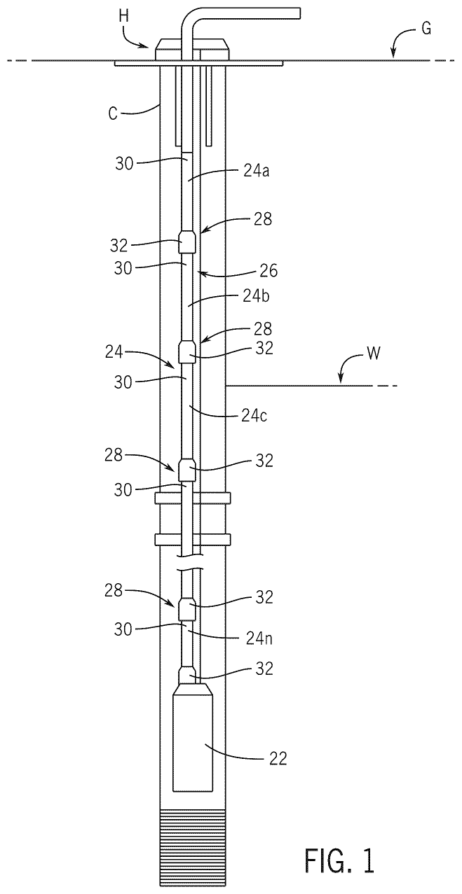

In the context of the present disclosure, and as shown in FIG. 1, a drop pipe system 20, such as for a well, has a pump 22 that is configured to be installed below ground level G, at the lower or bottom end of a drop pipe assembly or pipe string 24. The pipe string 24 and pump 22 may be received in an outer casing, such as a well casing C that keeps the surrounding ground from collapsing on the pipe string and allows ground water to reside around the pipe string up to the water table level W. The pump 22 is configured to pump fluid, such as water, from below up to ground level G or above. The system 20 has at least one power cord 26 that extends from a power source (not shown), such as a source of electricity, to the pump 22 below ground level G. The cord 26 delivers or provides power for operating the pump 22. The pipe string 24 of the system 20 may typically have a series of pipes, i.e., pipe sections or segments, which are connected end to end to form the drop pipe assembly or pipe string 24. The pipe string 24 connects the pump 22 to a part or structure (not shown) at a point, such as at a well head H, above ground level G where the water or fluid can be collected, stored, and distributed. The pipe string 24 has pipe joints 28 where each adjacent two pipes are connected to one another.

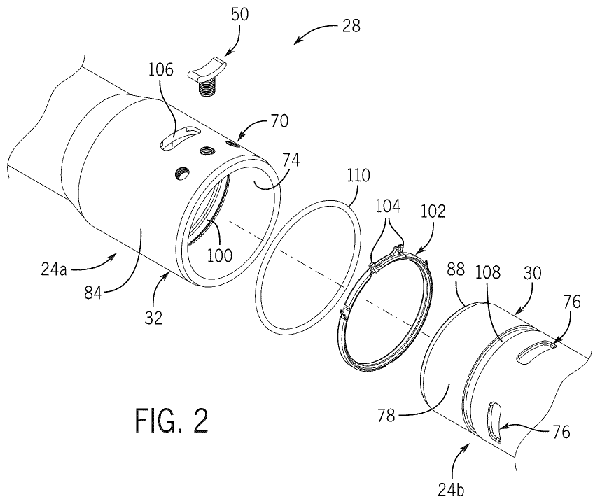

Thus, referring to FIGS. 1 and 2, the system 20 may be described as having at least a first pipe section or segment, i.e., a first pipe 24a, that has a first pipe first end 30 and a first pipe second end 32 opposite the first end. For the sake of description, the first end 30 of the first pipe 24a may be a male or spigot end of the pipe and the second end 32 of the first pipe may be a female or belled end of the pipe. However, in a particular application or use environment, this may be reversed, depending on how the pipe may attach to the pump 22, to a component C (shown only generically) at the well head H, or based on other pipe or system considerations. In this embodiment, the component C at the well head H of the system 20, near or above ground level G, may be connected or connectable to the first end 30 of the first pipe 24a in any known manner. The system 20 also has at least a second pipe section or segment, i.e., a second pipe 24b that has a second pipe first end 30 and a second pipe second end 32. The second pipe first end 30 is connected or connectable to the second end 32 of the first pipe 24a and thus, in this embodiment, the first end may be a male or spigot end of the second pipe. Likewise, the second end 32 of the second pipe 24b may again be a female or belled end of the second pipe. The second pipe second end 32 is connected or connectable to a first end 30 of yet another pipe, i.e., a third pipe 24c or alternatively to the pump 22 in a known manner at the bottom of the pipe string 24.

The system 20 may include any number of additional pipe sections or segments ‘n’, i.e., additional pipes 24c-24n that are connected to one another to form the pipe string 24. The number of pipes ‘n’ can vary widely depending on the length or depth of the pipe system or drop pipe system, the system requirements, the length of each pipe section or segment, and/or the like. The system 20 also may have separate couplers (not shown or described herein) that are configured to join adjacent pipe sections or segments to one another at each joint 28, thus defining a separate joint between each pipe and the coupler, instead of directly between two pipes. In the disclosed embodiments, the pipe joints 28 or couplings are formed by directly inserting a spigot end of one pipe section or segment, i.e., the first end 30 of the second pipe 24b into a belled end, i.e., the second end 32 of the first pipe 24a, without the use of a separate coupler.

According to the teachings of the present disclosure, the system 20 also has an anti-rotation apparatus at the pipe joints 28. The pipe joints 28 may include each joint between any two adjacent two pipes, a joint between a pipe and the pump 22, and/or a joint between a pipe and another component of the system, such as the component C at the well head end H of the system 20. The anti-rotation apparatus is configured to prevent relative rotation at each joint between pipes and/or or between a pipe and another part of the system, such as the pump or another component. This relative rotation can occur when the pump 22 is operated or when a torque is applied to the pipe string 24. The anti-rotation apparatus is shown and described herein at the joint 28 between the first pipe 24a and the second pipe 24b, though the apparatus can be used at any of the aforementioned joints or couplings. The anti-rotation apparatus generally includes an anti-rotation stop or insert piece and includes features provided on the joined pipe components, such as on the first pipe 24a and second pipe 24b, that accommodate and/or interact with the stop piece to prevent relative rotation between the joined parts. In the disclosed embodiments, the anti-rotation stop or insert piece is installed in a radial direction through at least a portion of the parts of the coupling or pipe joint 28 to rotationally interlock the first pipe 24a relative to the second pipe 24b. This anti-rotation apparatus addresses the above-described problems with prior art drop pipe and other pipe systems.

In the context of the present disclosure, the anti-rotation apparatus is provided for a pipe joint 28, which can be between the first pipe 24a and a structure, such as the component C, at the well head H near ground level G, between two pipes 24a and 24b, or between a last pipe ‘n’ and the pump 22 at the bottom free end of the pipe string 24 opposite the well head. The apparatus includes the anti-rotation stop or insert piece, which may have a body and a locking part. The anti-rotation apparatus may also be considered to include or to be incorporated into a coupling or pipe joint. The coupling or pipe joint may include a first joint part, such as a first pipe, and a second joint part, such as a second pipe, with an axis in a lengthwise direction of the coupling. The anti-rotation apparatus may also include a receiving receptacle provided in the first joint part of the coupling and a locking receptacle provided in the second joint part of the coupling. The body or a part of the body of the anti-rotation stop piece may be disposed in the receiving receptacle of the first joint part. The locking part may protrude in a radial direction relative to the axis and, when in a locked or engaged arrangement, may be disposed in the locking receptacle of the second joint part thereby preventing relative rotation about the axis between the first and second joint parts.

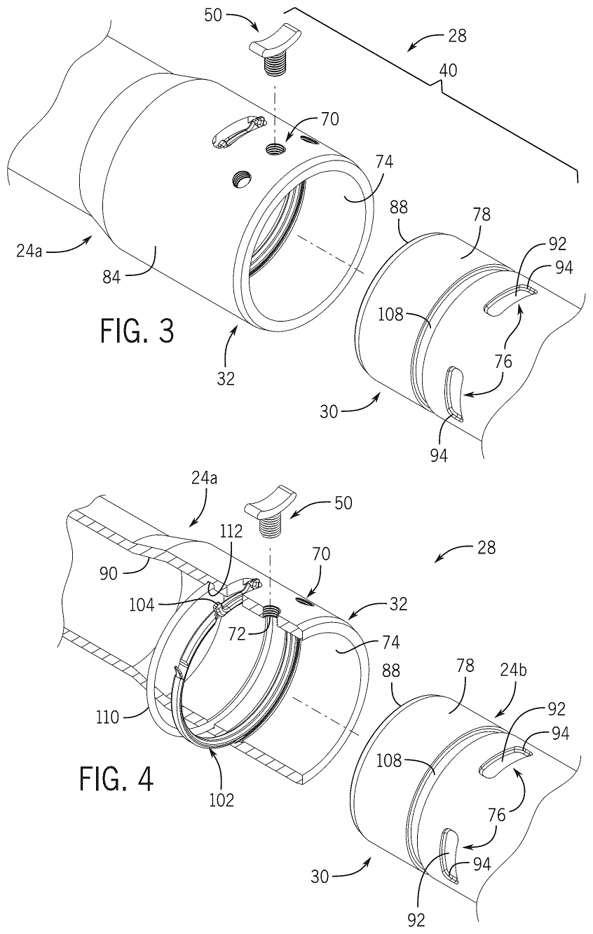

Referring to FIGS. 2-5B, one embodiment of an anti-rotation apparatus 40 for a pipe joint 28 is shown. In this embodiment, the anti-rotation apparatus 40 includes a stop piece 50 or insert piece. The stop piece 50 may be made of stiff but resilient plastic or plastic-type material, aluminum, composite, steel, or the like but other suitable materials may also be utilized. The stop piece 50 may be a single molded piece with a number of integrated features. Though only one stop piece 50 is shown and described for this embodiment, more than one stop piece may be utilized. Also, more than one retainer receptacle and/or locking receptacle can also be provided and used.

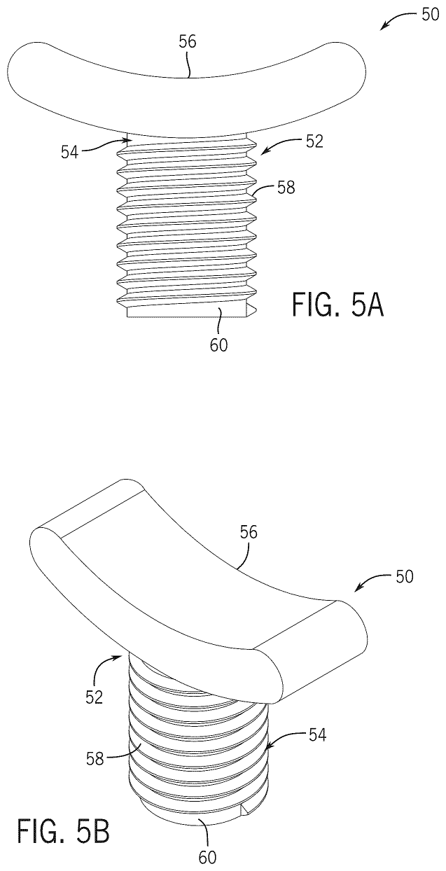

In this embodiment, as shown in FIGS. 5A and 5B, the stop piece 50 has a body 52 that is T-shaped and that includes a cylinder shaped stem 54 and a head 56 connected to one end, i.e., a proximal end of the stem of the body. In this example, all or part of the stem 54 includes mechanical threads 58 along the outer surface of the stem. The stem 54 also has a free end 60 disposed opposite the end to which the head 56 is attached. The body 52 of the stop piece 50 in this embodiment, including the head 56 and the stem 54 is or should be at least fairly rigid, stiff, or strong, as described above and further below. The stem 54 is configured to attach the stop piece 50 to the first joint part, i.e., the belled end 32 of a first pipe 24a to retain the stop piece on the female end of the pipe or coupling, once installed. The stem 54 also provides or forms the locking part of the anti-rotation apparatus 40 and, in part, provides the locking function for the apparatus.

In this embodiment, the head 56 of the body 52 is an elongate, curved part that is longer than a width of the stem 54. The head 56 is curved upward away from the proximal end of the stem 54. Thus, the width and curvature of the head 56 permits a user to grasp and hand-tighten or turn the stop piece 50, even if or when the head is borne against the outside diameter or surface of a joint part.

The foregoing described geometric features and aspects of the stop piece 50 may be modified or altered within the spirit and scope of this disclosure. The size and shape of the base or stem 54 and the head 56 can be varied while still functioning as intended. The stop piece 50, including the stem 54 and head 56 is relatively stiff in order to function as intended, as described herein. The stop piece 50 is configured to be sufficiently durable to allow for installing the stop piece in the pipe joint, retaining the stop piece in the installed arrangement, providing the locking part functionality, and removing the stop piece, if desired.

The various dimensions and shapes of the head 56 and the base or stem 54 may vary, as long as the stem is stiff enough and head is sufficiently sturdy and graspable to perform their intended function, as described below. The head 56 size and curvature can vary to accommodate a particular pipe diameter dimension. The stem 54 can vary in length and diameter and the threads 58 can vary in thread pitch. The body 52 material can also vary, depending on the pipe sizes and strength requirements of a given application and use environment.

With reference to FIGS. 2-4, 6, and 7, the anti-rotation apparatus 40 also includes a receiving receptacle in one of the joint parts for installing or receiving one of the stop pieces. In this embodiment, the first joint part is the female end or belled end, i.e., the second end 32 of the pipe 24a. In this embodiment, the receiving receptacle is provided in the form of one or more threaded bores or holes 70 through the wall of the pipe 24a for receiving the stem 54 of the stop piece 50. In one embodiment, only one hole 70 need be provided in order to install the stop piece and to yield the anti-rotation function, as should be apparent from the disclosure. However, in this embodiment, the joint part, i.e., the belled, female, or second end 32 of the first pipe 24a has a plurality or series of the holes 70, and more specifically, three of the holes 70, which are provided for a specific purpose, as discussed below. The series of holes 70 are spaced apart circumferentially on the pipe 24a at specific intervals for reasons described below. The stop piece 50 is installed in a radial direction toward the axis of the pipe 24a from outside the belled, female, or second end 32 of the pipe and then turned to thread the stop piece into place.

Also in this embodiment, each hole 70 is sized to accommodate the stop piece 50 and includes mechanical threads 72 that are configured to match and engage the threads 58 on the stem 54 of the stop piece. In this embodiment, the stem 54 of the stop piece 50 has a length that is sufficient so that, when installed in a hole 70, the free end 60 extends through the wall of the pipe 24a, protruding from an inner surface 74 of the pipe, and into the interior passage of the pipe. The protruding part of the fee end 60 acts as the locking part of the anti-rotation apparatus 40, as described below.

If more than one stop piece 50 is used or desired, a separate hole 70 may be provided for each stop piece. In this embodiment, if more than one stop piece 50 is desired for a given application, a separate series of the holes 70 can be provided for each stop piece. Additional holes 70 or series of holes 70 can be provided to yield more installation spots for the stop piece or pieces 50, if desired. For the anti-rotation function, however, only one stop piece 50 and one hole 70 need be provided.

Referring to FIGS. 2-4 and 12, the anti-rotation apparatus 40 further includes a locking receptacle that is formed on the other of the joint parts and that interacts with the stop piece to prevent relative rotation between the joint parts. In this embodiment, the other joint part is the male or spigot end, i.e., the first end 30 of the second pipe 24b. In this embodiment, the locking receptacle is provided in the form of one or more blind slots or grooves, i.e., locking grooves 76 formed along an outer surface 78 of the spigot or male end, i.e., the first end 30 of the second pipe 24b. As noted above, only one locking groove 76 is necessary to engage with the stop piece 50 to provide the anti-rotation function. However, in this example, multiple locking grooves 76 are provided for reasons discussed further below.

In this embodiment, each blind locking groove 76 is recessed into the outer surface 78 of the second pipe 24b and is formed to extend in a widthwise or circumferential direction around the second pipe 24b. The length of the locking groove or grooves 76 in the circumferential direction is larger than the size of the protruding free end 60 of the stem 54 on the stop piece 50, also for reasons discussed below. Further, the depth of the locking groove 76 is adequate enough to receive at least a portion of the free end 60 of the stem 54 that protrudes into the inner passage of the first pipe 24a. The depth of the locking groove 76 is sufficient to perform the anti-rotation locking function described herein. In this embodiment, the stop piece 50 has a circular locking part, i.e., the free end 60 of the stem 54 on the stop piece 50 whereas the locking groove 76 has an elongate oval shape. Each locking groove 76 has a predetermined length and spacing from the other such grooves. With one stop piece 50 and the multiple locking grooves 76, more than one anti-rotation landing spot is provided for the stem 54 of the stop piece 50. In this embodiment, the locking groove 76 number, length, and spacing, in combination with the spacing of the three holes 70, allows for the stop piece 50 to be installed no matter the relative rotational orientation between the two pipes. This feature is described in more detail below

As noted above, in one embodiment, one stop piece 50 and one locking groove 76 may be provided in a given anti-rotation apparatus. In another embodiment, one stop piece 50 and multiple locking grooves 76 may be provided. In yet another embodiment, two or more locking pieces 50 and at least two or more locking grooves 76 may be provided. If two or more locking grooves 76 are provided on the pipe 24b, the grooves 76 may be spaced apart in a circumferential direction around the pipe and may be spaced equidistant from one another around the pipe circumference. With more than one locking groove 76 per stop piece 50, more than one anti-rotation landing spot is provided. This will require less rotation between the female or belled end 32 and the male or spigot end 30 during installation or assembly of the pipe joint 28 before a stop piece 50 engages one of the locking grooves 76 to rotationally lock the two joint parts together. In one embodiment, if four locking grooves 76 are provided circumferentially and equidistant around the circumference of the pipe 24b, less than 90 degrees of relative rotation between the two pipes 24a and 24b is required to engage the anti-rotation apparatus 40. However, in the embodiment of FIGS. 2-12, one of the three holes 70 is always rotationally aligned with one of the locking grooves 76, so no rotation of the pipes 24a and 24b is required to find a landing spot for the stop piece 50 to engage with one of the locking grooves.

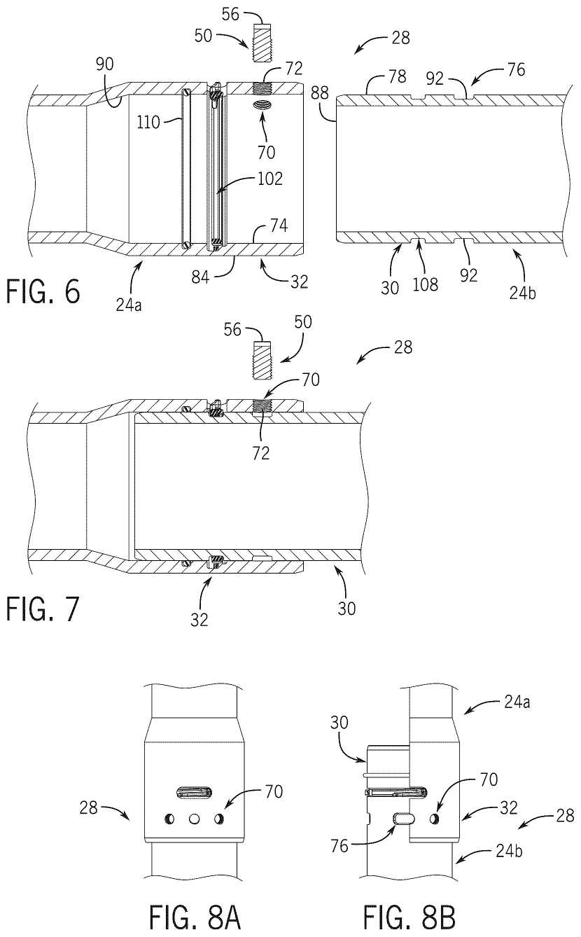

In this embodiment, the stop piece 50 is installed in one of the pipe joint parts by threading the stop piece into one of the threaded holes 70. Referring to FIGS. 2-7, the stop piece 50 is installed by inserting the threaded stem 54 into a selected one of the three holes 70 from the outer surface 84 outside of the belled, female, or second end 32 of the first pipe 24a. The stop piece 50 should be manually threaded into the hole 70, with the threads 72 in the hole and the threads 58 on the stem 54 engaged. This is done by grasping and rotating the head 56. In one embodiment, the stop piece 50 can be inserted only to a depth so that the free end 60 of the stem 54 does not protrude beyond or past the inner surface 74 into the inside passage of the pipe 24a, i.e., the stem still resides within the pipe wall in the hole 70. Alternatively, the stop piece 50 may be installed in the pipe joint 28 after the two joint parts, i.e., the male spigot end 30 of the second pipe 24b and the belled or female end 32 of the first pipe 24a, are joined. Sec FIGS. 6, 7, and 11. Once installed, the threads 58, 72 can hold or retain the stop piece 50 in place in the hole 70 and attached to the belled end 32 of the first pipe 24a. To remove the stop piece 50, the stop piece may be unscrewed in a reverse direction to back it out of the hole 70.

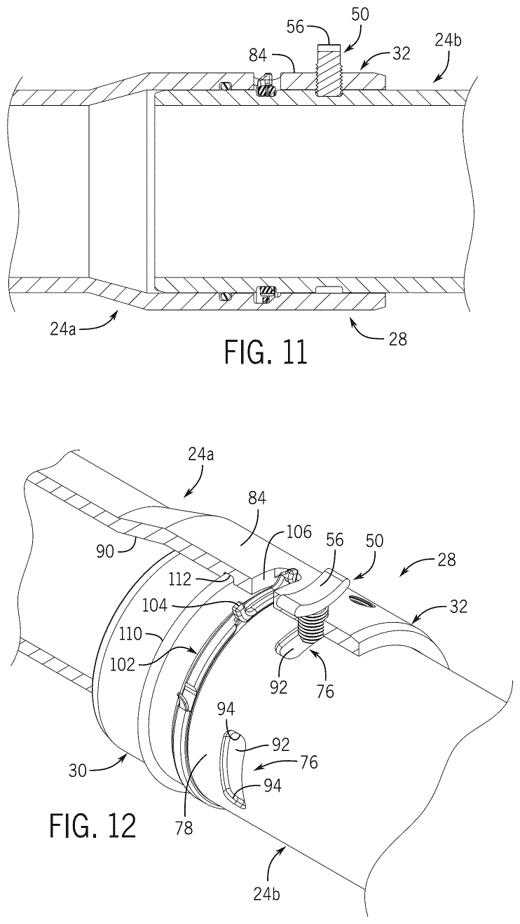

Referring to FIGS. 8A-12, the pipe joint 28 in this embodiment is assembled by inserting the male or spigot end, i.e., the first end 30 of the second pipe 24b into the female or belled end, i.e., the second end 32 of the first pipe 24a. Sec FIGS. 6, 7, 8A, and 8B. The pipe 24b can be fully received in the first pipe 24a, such as is shown in FIGS. 7-11. This also aligns the locking grooves 76 on the outer surface 78 of the second pipe 24b with the holes 70 in the axial direction. Thus, the anti-rotation apparatus 40 is ready to be engaged. The axial insertion amount of the second pipe 24b into the first pipe 24a can be designed to automatically set and axially align the parts, i.e., the retaining receptacle and the locking receptacle, of the anti-rotation apparatus. This can be achieved by a precise length of the spigot end or first end 30 of the second pipe 24b being received in the belled end or second end 32 of the first pipe 24a before a leading end 88 of the second pipe 24b hits a stop 90. In this embodiment, the stop 90 is created by the location at which the diameter defined by the inner surface 74 of the belled end or second end 32 of the first pipe 24a decreases to the nominal pipe diameter beyond the bell. See FIGS. 11 and 12.

As noted above, at least one of the holes 70 is automatically rotationally aligned with at least one of the locking grooves 76 in the circumferential direction in this embodiment at all times. Thus, if the stop piece 50 is not yet installed in any of the holes 70, the correct hole can be selected, and the stop piece can be screwed into the correct hole. If the stop piece is first partially installed in one of the holes 70, before the two pipes 24a and 24b are assembled, slight rotation might be necessary to align the stop piece 50 and its hole 70 with one of the locking grooves 76 because the stop piece might not be in a hole that is aligned with or overlapping one of the locking grooves. The stem 54 of the stop piece 50 should not protrude into the interior passage space of the belled end 32 of the first pipe 24a until the male spigot end 30 of the second pipe 24b is inserted. Otherwise, the stem 54 would prevent insertion.

Once the two pipes 24a and 24b are assembled and the stop piece 50 is installed in a hole 70 that overlaps with or aligns with that hole, the stop piece can be screwed fully into the hole and engage the locking groove. The free end 60 of the stop piece 50 will be moved radially inward into engagement with the locking groove 76. The free end 60 of the stem 54 on the stop piece 50 then resides in the locking groove 76 with the free end borne against or adjacent a groove bottom 92. The free end 60 of the stem 54 is also seated between groove end walls 94 of the locking groove 76. See FIGS. 7, 11, and 12. This arrangement captures the free end 60 of the stem 54 of the stop piece 50 between the groove end walls 94, which engages the anti-rotation apparatus 40 and creates a lock or interference that prevents substantial relative rotation of the pipes 24a and 24b. The end walls 94 of the locking grooves 76 can be shaped to match the shape of the free end 60 of the stem 54 for tight engagement.

In this embodiment, the pipes 24a and 24b may rotate relative to one another, even with the anti-rotation apparatus 40 in the locked state of FIGS. 11 and 12, but only to the degree permitted by the length of the locking groove 76. The free end 60 of the stem 54 will contact and be stopped by one of the groove end walls 94, preventing further rotation in that direction. The stop piece 50 and locking groove 76 will also prevent axial movement between the two pipes 24a and 24b. Thus, the stop piece 50 must be backed out of the hole, at least enough so that the free end 60 of the stem 54 retreats into the hole 70 sufficient to clear the locking groove 76. Then the two pipes may be axially separated, subject to release of an axial retainer as well.

The stop piece 50 in this embodiment can again be formed of any suitable material, such as various plastic materials, composites, metals, or the like, as long as it can function as described above. The size and shape of the body 52, including the head 56 and stem 54 of the stop piece 50, can be varied can also vary according to the needs of a given application and use or as desired. The holes 70 and locking grooves 76 can thus also be modified accordingly to accommodate such modification and to function as intended.

In this embodiment, the rotational alignment of the anti-rotation elements is achieved from immediate assembly of the pipe joint, as noted above, unless the stop piece is already installed in one of the holes 70, as noted above. Because of this, the bell/spigot joint can be assembled in any relative rotational alignment. As shown in FIGS. 8A-10F, the holes 70 of the series of three holes are spaced apart at a specific distance in the circumferential direction on the pipe 24a. The locking grooves 76 also have a specific length and spacing in the circumferential direction. When the two pipes 24a and 24b are fully assembled to the stop 90, the locking grooves 76 and the series of holes 70 are in position to align or overlap one another. Sec FIGS. 8A and 8B.

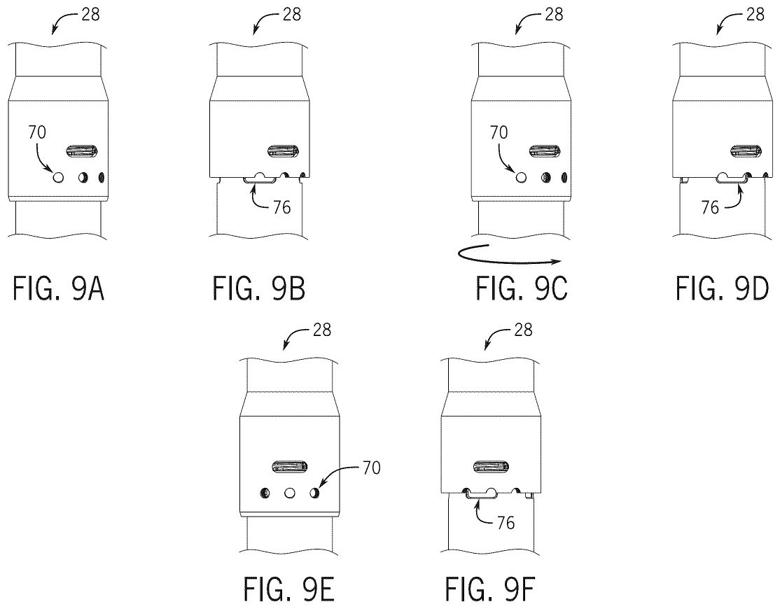

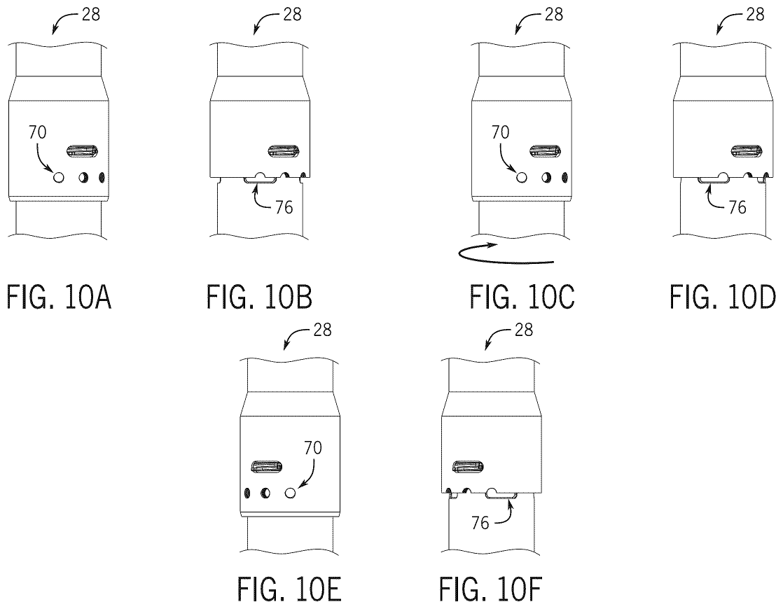

FIGS. 9A-10B show that, regardless of the relative rotational positions of the two pipes 24a and 24b, a portion of one of the locking grooves 76 will always be positioned beneath at least one of the holes 70. If the two pipes 24a and 24b are rotated relative to one another in either direction, as one locking groove 76 starts to clear a hole 70 at one end of the series, another locking groove starts to align with the hole at the other end of the series. The multiple circumferential grooves 76 in the spigot end 30 and the three threaded holes 70 in the belled end 32 are arranged at appropriate intervals such that at least one of the three holes and one portion of one of the grooves will always overlap. This allows for full engagement, i.e., full screwed in insertion of the threaded stop piece 50. Because of this, the bell/spigot joint can be assembled with the two pipes 24a and 24b in any relative rotational alignment. Thus, at least one hole 70 in the series of holes is always positioned over a part of one of the locking grooves 76. The stop piece 50 can be manually screwed by hand using the head 56 into position in the correct hole 70 to engage the locking feature. Once engaged, the pipe joint components are prevented from further rotating relative to one another, beyond the extent permitted by the locking groove 76 length in this embodiment. See FIGS. 11 and 12.

The integrity of the pipe joint 28 in the lengthwise direction can be axially retained in any suitable manner, and independent of the anti-rotation apparatus 40 described and disclosed herein. The joint 28 is axially retained in the above described embodiment of FIGS. 2-12 using the patent owner's CERTA-LOK CLIC technology and components, which employ an automatic spline locking feature.

Briefly, a spline groove 100 is provided on the inner surface 74 of the belled end or second end 32 of the first pipe 24a. A squeezable retainer ring or spline 102 is seated in the spline groove 100 and has squeeze tabs 104 that can be used to manually expand the ring diameter. The squeeze tabs 104 protrude from an aperture 106 in the wall of the belled end or second end 32. A corresponding retainer groove 108 is provided on the outer surface 78 of the spigot or first end 30 of the second pipe 24b. The spline groove 100 and retainer groove 108, as well as the spline 102, are cooperatively shaped, as is known, so that the spline 102 automatically locks and axially retains the two pipes 24a and 24b in the engaged state once assembled. A seal 110, i.e., a gasket or O-ring, can also be seated in a seal groove 112, which may be provided on one of the joint parts, such as on the inner surface 74 of the belled second end 32 of the first pipe 24a. To release this axial retention mechanism of the pipe joint 28, the tabs 104 of the spline 102 can be squeezed together within the aperture 106. This expands the diameter of the spline 102, releasing it from the retainer groove 108, and permitting the pipes 24a and 24b to be pulled apart. The anti-rotation apparatus 40 in this embodiment would prevent separation of the two pipes 24a and 24b unless the stop piece 50 is removed, as discussed above.

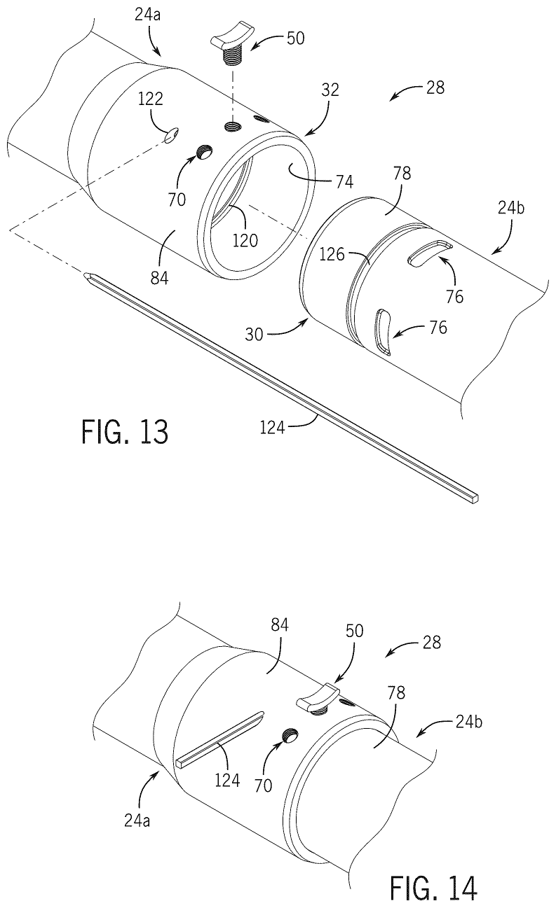

As shown in FIGS. 13 and 14, the pipe joint 28 can be axially retained using other methods. In one embodiment, the pipe joint 28 can be axially retained using the patent owner's CERTA-LOK spline technology and components, which are manually installed. Briefly, a spline groove 120 is again provided on the inner surface 74 of the belled end or second end 32 of the first pipe 24a. An opening 122 is provided through the wall of the belled second end 32 of the first pipe 24a and is aligned with the spline groove 120. An elongate, stiff but flexible spline 124 is also provided. A corresponding retainer groove 126 is again provided on the outer surface 78 of the spigot or first end 30 of the second pipe 24b. The spline groove 120 and retainer groove 126, as well as the spline 102, are again cooperatively shaped, as is known. When the two pipes 24a and 24b are assembled, the spline 124 is manually inserted through the opening 122 into the now axially aligned spline groove 120 and retainer groove 126. The spline 124 locks and axially retains the two pipes 24a and 24b in the engaged state. Though not shown in this embodiment, a seal, i.e., a gasket or O-ring, can also be seated in a seal groove, which may be provided on one of the joint parts. To release the pipe joint 28, an exposed tail of the spline 124, protruding outside the pipe joint 28 as shown in FIG. 11, can be forcibly pulled to withdraw the spline from the grooves 120 and 126. This eliminates the retention feature, permitting the pipes 24a and 24b to be pulled apart, as long as the stop piece 50 is also removed. The anti-rotation apparatus 40 again would prevent axial separation of the pipes 24a and 24b, as described above, unless it is removed. Still other joint retainer configurations may also be used, independent of the disclosed anti-rotation feature.

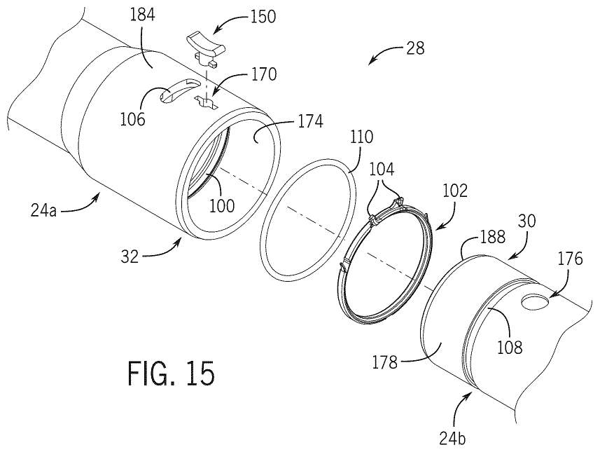

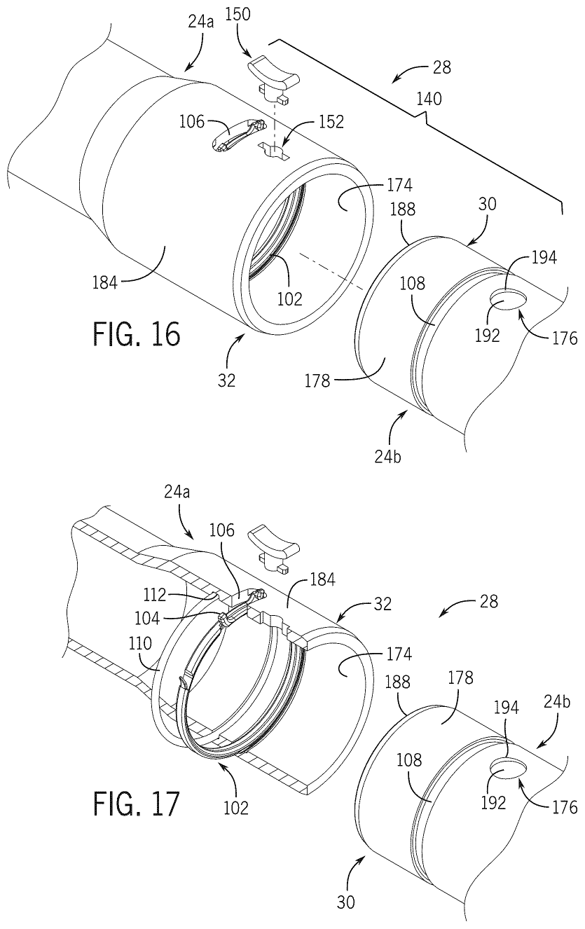

As noted above, the anti-rotation apparatus, including the stop piece, can vary in configuration and construction, as can other aspect of the anti-rotation apparatus. FIGS. 15-24 show another embodiment of an anti-rotation apparatus 140 for a pipe joint 28. FIGS. 15-17 show views of the pipe joint assembly 28 in this embodiment. Much of the pipe joint detail discussed above is not repeated below for the sake of brevity. However, numerous aspects of the above-described anti-rotation apparatus are equally applicable to this embodiment. In this embodiment, the anti-rotation apparatus includes a stop piece 150 or multiple stop pieces. Each has a locking part in the form of a key-type element on a stem of the stop piece.

In this embodiment, the anti-rotation apparatus 140 again includes a locking part defined by the stop piece 150. In this embodiment, the stop piece 150 may again be made of stiff but resilient plastic or plastic-type material, aluminum, composite, steel, or the like but other suitable materials may also be utilized. The stop piece 150 may be a single molded piece with a number of integrated features. Though only one stop piece 150 is shown and described for this embodiment, more than one stop piece may be utilized. Also, more than one retainer receptacle and/or locking receptacle can also be provided and used.

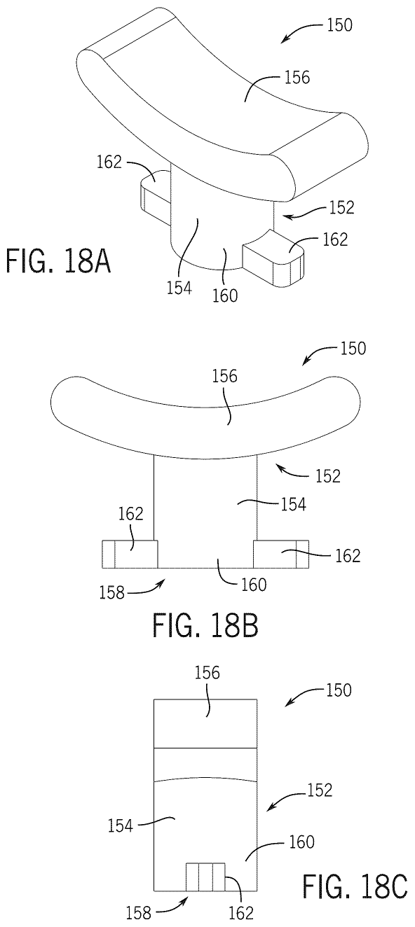

In this embodiment, as shown in FIGS. 18A-18C, the stop piece 150 has a body 52 that is T-shaped and that includes a cylinder shaped stem 154 and a head 156 connected to a proximal end of the stem. The stem 154 also has a free end 160 disposed opposite the end to which the head 156 is attached. The body 152 in this embodiment, including the head 156 and the stem 154 is or should be at least fairly rigid, stiff, or strong, as described above and further below. The stem 154 is configured to attach the stop piece 150 to the first joint part, i.e., the belled end 32 of a first pipe 24a to retain the stop piece on the female end of the pipe or coupling, once installed. The stem 154 also provides or forms the locking part of the anti-rotation apparatus 40 and, in part, provides the locking function for the apparatus. A key 158 is provided on the free end 160 of the stem 154. The key 158 in this embodiment includes a pair of bosses 162 protruding radially from the stem 154 in opposite directions.

In this embodiment, the head 156 of the body 152 is an elongate, curved part that is longer than a width of the stem 154. The head 156 is curved upward away from the proximal end of the stem 154. Thus, the width and curvature of the head 156 again permits a user to grasp and hand-tighten or turn the stop piece 150.

The foregoing described geometric features and aspects of the stop piece 150 may be modified or altered within the spirit and scope of this disclosure. The size and shape of the base or stem 154, the key 158, and the head 156 can be varied while still functioning as intended. The stop piece 150, including the stem 154, key 158, and head 156 is relatively stiff in order to function as intended, as described herein. The stop piece 150 is configured to be sufficiently durable to allow for installing the stop piece in the pipe joint, retaining the stop piece in the installed arrangement, providing the locking part functionality, and removing the stop piece, if desired.

With reference to FIGS. 15-17, 19, and 20, the anti-rotation apparatus 140 also includes a receiving receptacle in one of the joint parts for installing or receiving one of the stop pieces. In this embodiment, the first joint part is the female end or belled end, i.e., the second end 32 of the pipe 24a. In this embodiment, the receiving receptacle is provided in the form of a keyhole or way 170 through the wall of the pipe 24a for receiving the stem 154 and key 158 of the stop piece 150. The keyhole or way 170 includes a pair of opposed notches or cutouts 172 180 degrees apart around the keyhole 170. These notches are positioned and sized to accommodate insertion of the key 158, including the bosses 162, as described below. In one embodiment, only one keyhole 170 need be provided in order to install the stop piece 150 and to yield the anti-rotation function, as should be apparent from the disclosure. However, additional keyholes may be provided for mor landing spots for the one or for multiple of the stop pieces 150. The stop piece 150 is installed in a radial direction toward the axis of the pipe 24a from outside the belled, female, or second end 32 of the first pipe 24a and is then turned to misalign the bosses 162 with the notches 172. Thus, the combination of the head 156 and the bosses 162 can define the retaining portion aspect of the stop piece 150.

Also in this embodiment, the keyhole 170 is sized to accommodate the stop piece 150, i.e., to match and engage the key 158 on the stem 154. In this embodiment, the stem 154 of the stop piece 150 has a length that is sufficient so that, when installed in the keyhole 170, the free end 160 extends through the wall of the pipe 24a, protruding from an inner surface 174 of the pipe, and into the interior passage of the pipe. The protruding part of the fee end 160, including the key 158, acts as the locking part of the anti-rotation apparatus 140, as described below.

If more than one stop piece 150 is used or desired, a separate keyhole 170 may be provided for each stop piece. Additional keyholes 170 can be provided to yield more installation spots for the stop piece or pieces 150, if desired. For the anti-rotation function, however, only one stop piece 150 and one keyhole 170 need be provided.

Referring to FIGS. 15-17, 22, and 24, the anti-rotation apparatus 140 further includes a locking receptacle that is formed on the other of the joint parts and that interacts with the stop piece to prevent relative rotation between the joint parts. In this embodiment, the other joint part is the male or spigot end, i.e., the first end 30 of the second pipe 24b. In this embodiment, the locking receptacle is provided in the form of one or more circular recesses, i.e., locking recesses 176 formed along an outer surface 178 of the spigot or male end, i.e., the first end 30 of the second pipe 24b. As noted above, only one locking recess 176 is necessary to engage with the stop piece 150 to provide the anti-rotation function. However, additional locking recess may be provided to create more lading spots for the locking part.

In this embodiment, the locking recess 176 is recessed into the outer surface 178 of the second pipe 24b. The diameter of the locking recess 176 is large enough to accommodate both the free end of the stem 154 and the width of the key 158, as defined by the combined length of the bosses 162 and the diameter of the stem, also for reasons discussed below. Further, the depth of the locking recess 176 is adequate enough to receive at least a portion of the free end 160 of the stem 154 that protrudes into the inner passage of the first pipe 24a. The depth of the locking recess 176 is sufficient to perform the anti-rotation locking function described herein. In this embodiment, the stop piece 150 is rotated, which rotates the bosses 162. The locking recess 176 has a circular shape with a diameter that can accommodate the bosses 162 therein, while allowing rotation of the stop piece 150.

If two or more locking recesses 176 are provided on the pipe 24b, the recess may be spaced apart in a circumferential direction around the pipe and may be spaced equidistant from one another around the pipe circumference. With more than one locking recess 176 per stop piece 150, more than one anti-rotation landing spot is provided. This would require less rotation between the female or belled end 32 and the male or spigot end 30 during installation or assembly of the pipe joint 28 before a stop piece 150 can engage one of the locking recesses 176 to rotationally lock the two joint parts together.

In this embodiment, the stop piece 150 is installed in one of the pipe joint parts by inserting the stop piece into the keyhole. Referring to FIGS. 15-20, the stop piece 150 is installed by inserting the key 158 of the stem 154 into the keyhole 170 from an outer surface 184 of the belled, female, or second end 32 of the first pipe 24a. The bosses 162 of the key 158 should be manually aligned with the notches 172 of the keyhole 170 so that the key can pass through the keyhole. This is done by grasping and rotating the head 156. Once installed, the stop piece 150 is retained in place, in part by the head 156, which cannot fit through the keyhole 170, and by the bosses 162, unless still aligned with the notches 172 in the keyhole. To remove the stop piece 150, the stop piece may be rotated to align the bosses 162 of the key 158 with the notches so that the stop piece can be withdrawn from the keyhole 170.

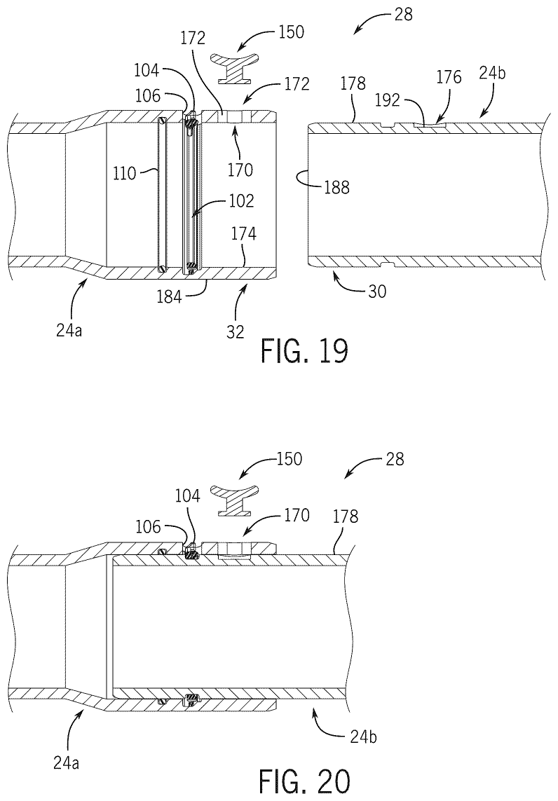

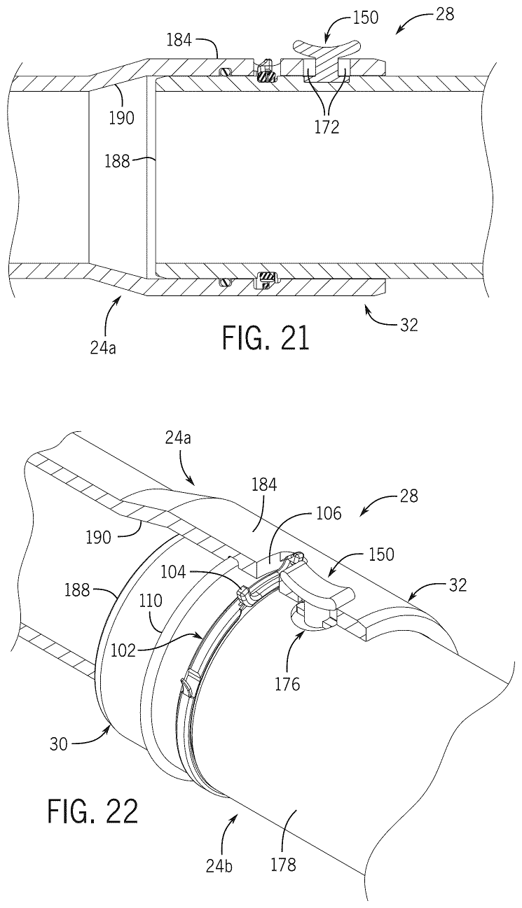

Referring to FIGS. 19-24, the pipe joint 28 in this embodiment is assembled by inserting the male or spigot end, i.e., the first end 30 of the second pipe 24b into the female or belled end, i.e., the second end 32 of the first pipe 24a. See FIGS. 19 and 20. The pipe 24b can be fully received in the first pipe 24a, such as is shown in FIGS. 20-24. This also aligns the locking recess 176 on the outer surface 178 of the second pipe 24b with the keyhole 170 in the axial direction. Thus, the anti-rotation apparatus 140 is ready to be engaged. The axial insertion amount of the second pipe 24b into the first pipe 24a can be designed to automatically set and axially align the parts, i.e., the retaining receptacle and the locking receptacle, of the anti-rotation apparatus. This can be achieved by a precise length of the spigot end or first end 30 of the second pipe 24b being received in the belled end or second end 32 of the first pipe 24a before a leading end 188 of the second pipe 24b hits a stop 190. In this embodiment, the stop 190 is again created by the location at which the diameter defined by the inner surface 174 of the belled end or second end 32 of the first pipe 24a decreases to the nominal pipe diameter beyond the bell. See FIGS. 20 and 21.

As noted above, the keyhole 170 may not yet be rotationally aligned with the locking recess 176 in the circumferential direction. Thus, rotation of the two pipes 24a and 24b relative to one another might be necessary to align the stop piece 150 and the keyhole 170 with the locking groove 176. Once the two pipes 24a and 24b are assembled and the keyhole 170 is aligned with or overlaps with the locking recess 176, the stop piece 150 is installed in the keyhole 170, as shown in FIGS. 20-22. The key 158 including the bosses 162 is aligned with the notches 172 of the keyhole to insert the stop piece 150. The free end 160 of the stop piece 150 will be moved radially inward into engagement with the locking recess 176. The free end 160 of the stem 154 then resides in the locking recess 176 and is borne against or adjacent a bottom 192 of the recess 176. The bosses 162 of the key 158 on the free end 160 of the stem 154 are also seated within the recess side wall 194 that surrounds the bottom 192 and defines the locking recess 176. See FIGS. 21 and 22.

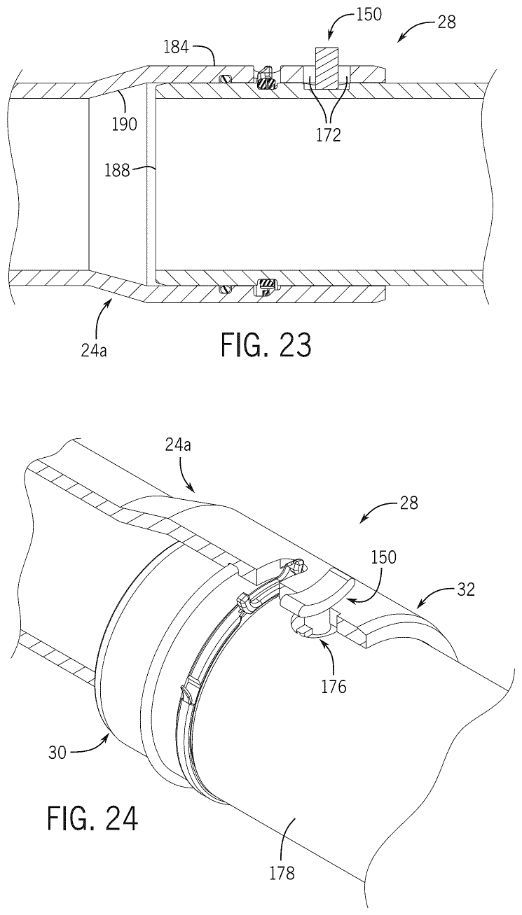

In this arrangement, the free end 160 of the stem 154, including the bosses 162 are captured within the side wall 194 of the locking recess 176, which engages the anti-rotation apparatus 140 and creates a lock or interference that prevents relative rotation of the pipes 24a and 24b. As show in FIGS. 23 and 24, the stop piece, including the key 158, can be manually rotated, such as by 90 degrees in either direction, using the head 156 to misalign the bosses 162 and the notches 172 of the keyhole 170. In this orientation, the bosses are also captured under the inner surface 174 of the pie wall so that the stop piece 150 cannot be withdrawn from the keyhole 170. The side wall 194 of the locking recess 176 is circular so that the key 158 of the stop piece 150 can be rotated once engaged with the locking recess 176. Though not disclosed any further herein, the locking recess 176 and/or the stop piece 150 can be configured to limit rotation of the stop piece between the locked position or orientation of FIGS. 23 and 24 and the unlocked position or orientation of FIGS. 21 and 22. The bosses 172 can also be sized or formed to interfere, or to have another type of retention mechanism, within the space and against the surfaces of the recess bottom 192 and the inner surface 174 of the pipe 24a in the locked position to inhibit unintended rotation back to the unlocked position.

In this embodiment, the pipes 24a and 24b may not rotate relative to one another, once the stop piece 150 is in place and in the locked position or orientation. The ends of the bosses will contact the side wall 194 of the locking recess 176, preventing relative rotation of the two pipes 24a and 24b. The stop piece 150 and locking recess 176 will also prevent axial movement between the two pipes 24a and 24b. Thus, the stop piece 150 must be backed out of the keyhole 170 sufficient to retreat from the locking recess 176. Then the two pipes may be axially separated, subject to release of an axial retainer as well.

The stop piece 150 in this embodiment can again be formed of any suitable material, such as various plastic materials, composites, metals, or the like, as long as it can function as described above. The size and shape of the body 152, including the head 156, the stem 154, and the key 158 of the stop piece 150 can also vary according to the needs of a given application and use, or as desired. The keyhole 170 or keyholes and locking recess 176 or recesses can thus also be modified accordingly to accommodate such modification and to function as intended.

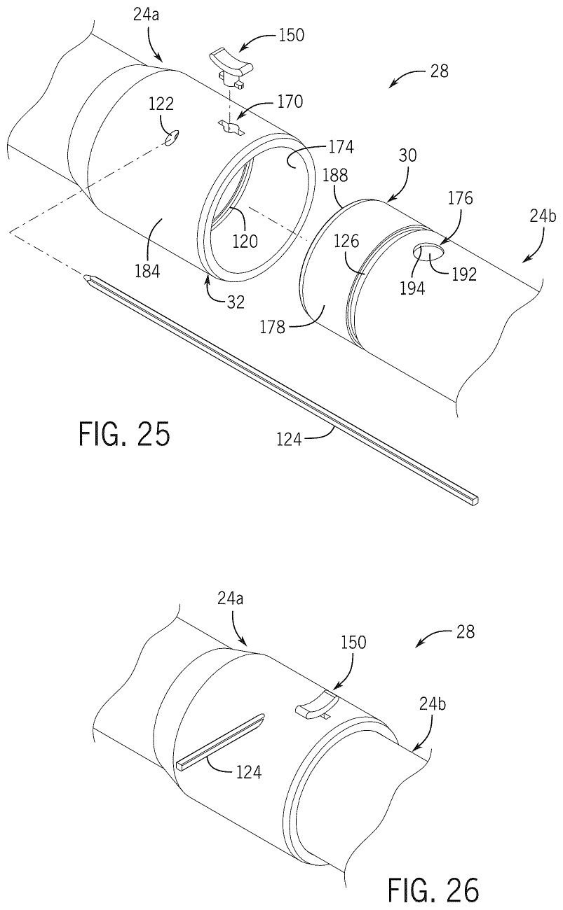

The integrity of the pipe joint 28 in the lengthwise direction can again be axially retained in any suitable manner. The joint is retained in the embodiment of FIGS. 15-24 using the applicant's CERTA-LOK CLIC components, which employ an automatic spline locking feature, as described above. As shown in FIGS. 25 and 26, the pipe joint 28 can be axially retained using the applicant's CERA-LOK spline that is manually installed. Again, other joint retainer configurations may also be used, independent of the disclosed anti-rotation feature.

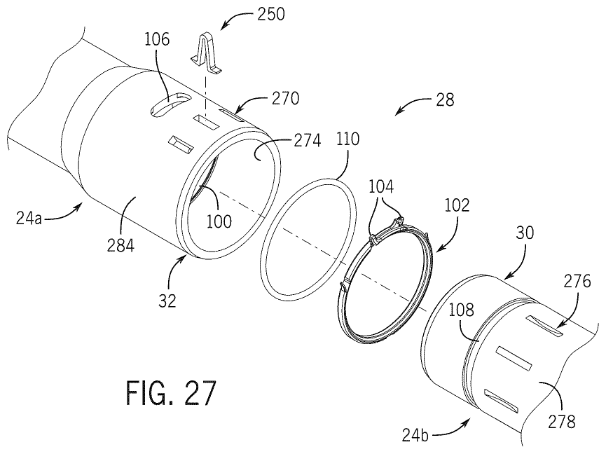

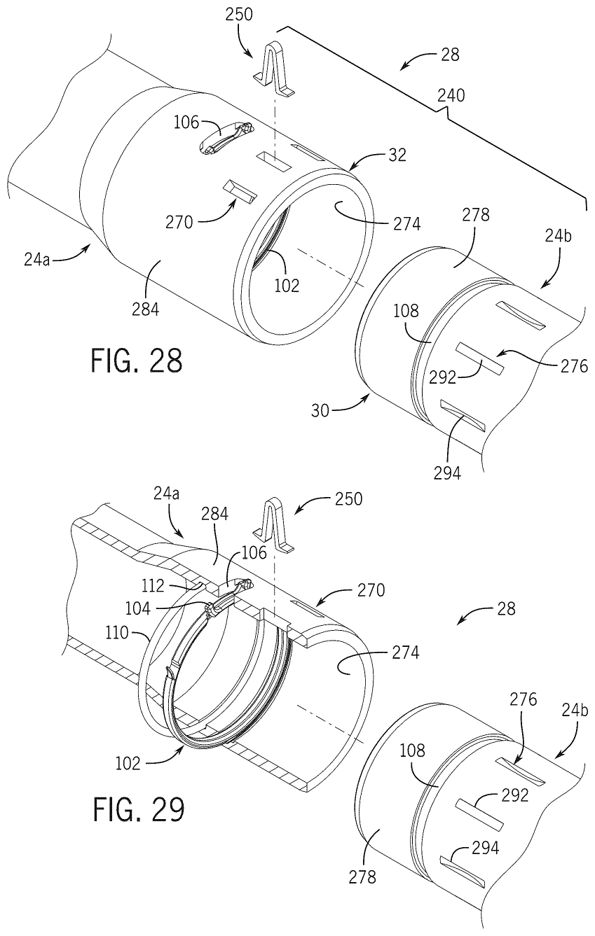

FIGS. 27-37 show another embodiment of an anti-rotation apparatus 240 for a pipe joint 28. Much of the pipe joint detail discussed above is not repeated below for the sake of brevity. However, numerous aspects of the above-described anti-rotation apparatus are equally applicable to this embodiment. In this embodiment, the anti-rotation apparatus includes a stop piece 250 or multiple stop pieces. Each has a locking part in the form of movable feet on a resilient, flexible body of the stop piece.

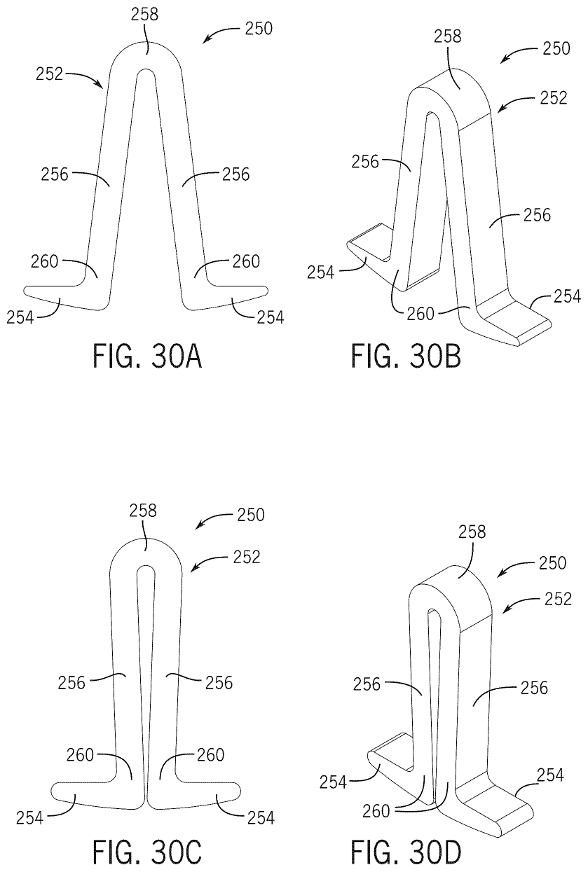

In this embodiment, with reference to FIGS. 27-30D, the anti-rotation apparatus 240 includes a locking part. In this example, the insert, i.e., the stop piece 250 has an A-shaped body 252 that is resiliently flexible. The body 252 has two resilient legs 256 connected to one another at a joint or elbow 258. The legs 256 extend away from one another from the elbow 258 at an acute angle, thus the A-shape. Each leg 256 has a free end 260 with a protrusion or foot 254, i.e., the locking part, protruding outward away from one another. The legs 256 may be squeezed toward one another or together by bending the body 252 about the elbow 258. See FIGS. 30C and 30D. The feet 254 extend or protrude outward in opposite directions beyond the extent of the width of the legs. Sec FIGS. 30A-30D.

In this embodiment, the anti-rotation apparatus 240 also has a retaining receptacle to install and retain the stop piece 250, including the locking part. With reference to FIGS. 27-29, 33A, 33B, and 37, the female end, i.e., belled end 32 of the first pipe 24a includes the retaining receptacle as a series of through openings, i.e., windows or slots 270 through the wall of the pipe. Each slot 270 is for selectively receiving the legs 256 of the stop piece 250. These slots 270 are elongate and oriented axially in the lengthwise direction of the pipe 24a. The slots 270 of the series of slots are arranged spaced apart circumferentially around the pipe 24a. If more than one stop piece 250 is used, the female or second end 32 of the first pipe 24a could include a series of the slots 270 for each stop piece. Alternatively, the female end of the pipe could include just one slot or window for a single stop piece to be installed. For the anti-rotation function, however, only one stop piece and one slot need be utilized.

In use, the stop piece 250 is squeezed and installed through one of the slots 270 such that the free ends 260 and the feet 254 protrude through the slot 270 beyond the inner surface 274 of the belled or second end 32 of the pipe 24a. In this embodiment, the stop piece should not be installed until the two pipes 24a and 24b are assembled. Otherwise, the slot 270 will not retain the stop piece 250 in the slot. Though not shown herein, a feature or features may be provided on the legs 256 of the body 252 that would hold the stop piece 250 in the slot until the pipes are assembled.

In this embodiment, the anti-rotation apparatus 240 further includes a locking receptacle to engage the locking part to provide the anti-rotation function. Referring to FIGS. 27-29 and 37, the locking receptacle is provided on the male, spigot, or first end 30 of the second pipe 24b in the form of one or more blind grooves, i.e., locking grooves 276 in the outer surface 278 or outside diameter surface of the pipe. The locking grooves 276 are formed to extend in the lengthwise or axial direction of the second pipe 24b and are also spaced apart circumferentially around the pipe in this embodiment. See FIGS. 27-29. In this embodiment, the locking grooves 276 are provided around the circumference of the first end 30 of the second pipe 24b. With one stop piece 250 and more than one locking groove 276, more than one anti-rotation landing spot is provided. This requires less rotation between the female end 32 and the male spigot 30 before the stop piece 250 can engage one of the locking grooves 276 to rotationally lock the two joint parts together.

In this embodiment, the second end 32 of the first pipe 24a has a series of three slots 270 and the first end 30 of the second pipe has multiple locking grooves 276 provided on the outer surface 278. The spacing between the three slots 270 may be equidistant and the spacing between the locking grooves 276 around the outside of the first end 30 of the second pipe 24b can also be equidistant. However, the spacing between the slots 270 can be the same as, or different than, the spacing between the locking grooves 276. Thus, the amount of relative rotation between the pipe 24a and 24b that is required to line up one of the slots 270 with one of the locking grooves can be predetermined and can be reduced.

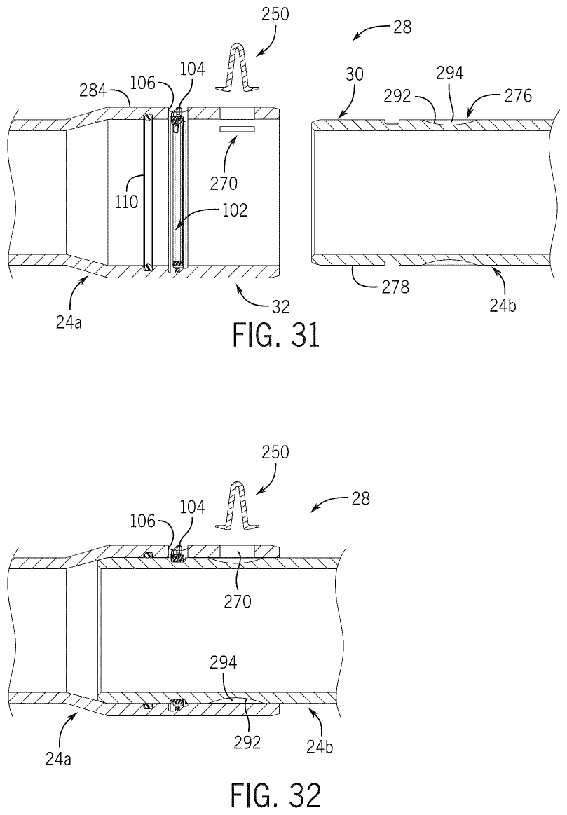

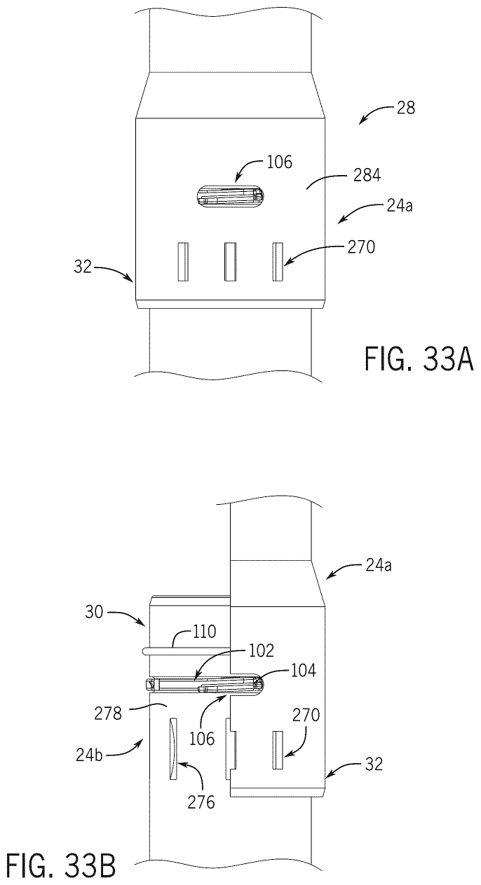

The pipe joint 28 is assembled as shown and described with reference to FIGS. 30A-37. As shown in FIGS. 31 and 32, the spigot or first end 30 of the second pipe 24b is inserted into the open belled or second end 32 of the first pipe 24a. The pipe 24a can be inserted until the pipe 24b until the leading end 288 of the second pipe bottoms out against the stop 290 within the belled end 32. In this axial arrangement, the locking grooves 276 and the series of holes 270 are aligned in the axial direction but may be offset or misaligned with one another in the circumferential direction. The two pipes 24a and 24b can be rotated relative to one another about the axis until one of the holes 270 overlaps one of the locking grooves 276. As noted above, the number and spacing of the locking grooves 276 and the spacing of the three holes 270 can be such that only minimal rotation is required until such alignment occurs. See FIGS. 33a and 33B.

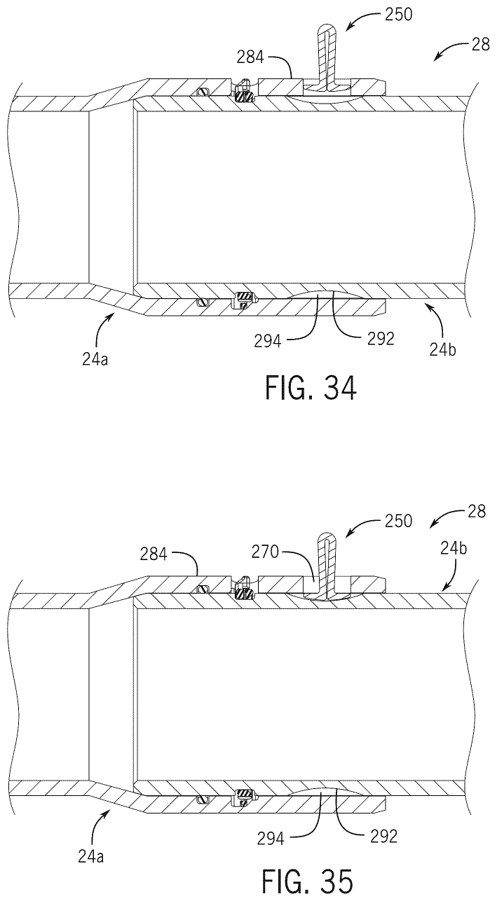

The stop piece 250 in this example is generally A-shaped while in its open, rest position, as shown in FIGS. 30A and 30B. The stop piece 250 is squeezed by hand into a narrow orientation as shown in FIGS. 30C, 30D, and 34 in order to be inserted into one of the slots 270 in the pipe belled end 32. Any single one of the slots 270 in the belled end 32 must be visually in alignment with any one of the locking grooves 276 in the spigot end of the other pipe. Thus, the pipe joint 28 needs to be in the correct rotational orientation during pipe assembly or must be rotated after assembly of the pipes so a slot 270 and a groove 276 are in alignment. The multiple locking grooves in the spigot end 30 and multiple slots 270 in the belled end 32 are provided and are arranged at intervals to minimize the work, i.e., the degree of rotation, needed to achieve alignment.

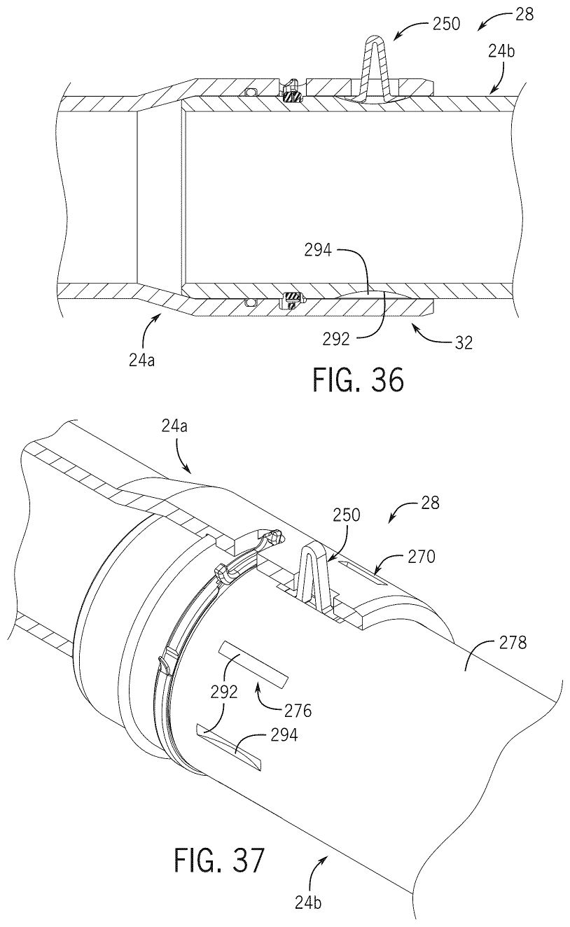

As shown in FIG. 34, the stop piece 250 is squeezed into a narrow profile by hand and placed in the correct slot 270 in a radial direction from an outer surface 284 of the pipe 24a toward the axis. As shown in FIG. 35, the stop piece 250 will seat in and be borne against a bottom 292 of the locking groove 276. At this time, the stop piece 250 is released and allowed to revert to its open state. See FIGS. 36 and 37. The free ends 260 and the feet 254, as well as the bottom 292 of the locking groove 276, are configured so that the feet can hook under the inner surface 274 of the belled end 32 within the slot 270. The feet 254 will prevent the stop piece 250 from exiting, i.e., from backing out of, its position in the slot 270.

In this example, the bottom 292 of the locking groove 276 is curved from end to end, being deeper toward the center and shallower toward the opposed ends. See FIGS. 36 and 37. The bottom of the feet 254 are likewise curved to match, allowing for smooth expansion of the stop piece 250 within the slot 276. However, other shapes are also possible for both the locking grooves 276 in the outer surface 278 of the pipe 24b and the feet 254 of the stop piece 250. Once in the expanded state, the sides of the free ends 260 and feet 254 of the stop piece are captured between side walls 294 of the locking groove 276. Thus, these features function as the locking part to prevent rotation of the two pipes 24a and 24b relative to one another, unless and until the stop piece is removed. Only one stop piece 250 is intended to be required to lock rotation in the pipe joint assembly 28. If more are required or desired to accommodate higher torque, additional slots 270 or arrays of the slots in the joint part may be incorporated in the design. The stop piece 250 can be manually squeezed and removed from the slot 270 to allow for disassembly of the pipe joint assembly 28.

In this embodiment, once one of the locking grooves 276 in the spigot end 30 of the second pipe 24b is aligned in the radial direction with the stop piece 250, the anti-rotation feature can engage. The axial insertion amount of the spigot end 30 of the second pipe 24b can again be designed to automatically set to a desired depth, such as via the stop 290, to properly position the anti-rotation apparatus components to create the interlock. Once one of the locking grooves 276 in the spigot or male end 30 of the second pipe 24b is rotationally aligned with the stop piece 250, the stop piece can move relatively freely. The feet 254 will spring toward the opposite axial ends of the locking groove 276, once the stop piece 250 is pushed inward into the locking groove 276, to engage the locking feature.

The stop piece 250 in this embodiment can again be formed of any suitable material, such as various plastic materials, as long as it can function as described above. The size and shape of the body 252, including the legs 256, feet 254, and elbow 258, of the stop piece 250 can also vary according to the needs for a specific use and application environment.

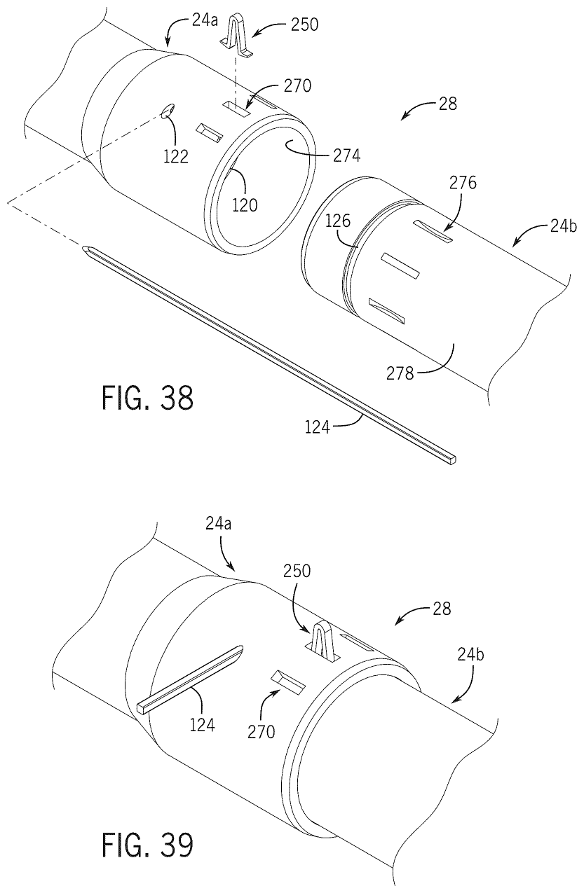

The integrity of the pipe joint 28 in the lengthwise direction can again be axially retained in any suitable manner. The joint 28 is retained in the embodiment of FIGS. 27-37 using the applicant's CERTA-LOK CLIC components, which employ an automatic spline locking feature, as noted above. As shown in FIGS. 38 and 39, the pipe joint 28 can be axially retained using the applicant's CERTA-LOK spline that is manually installed. Again, other joint retainer configurations may also be used, independent of the disclosed anti-rotation feature.

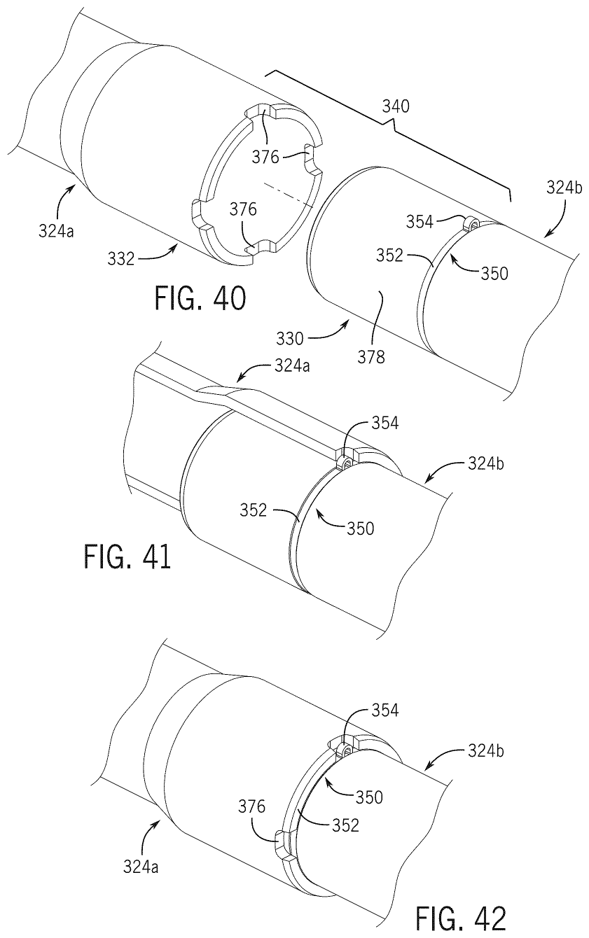

FIGS. 40-42 show simplified views of a pipe joint 28 that includes another embodiment of an anti-rotation apparatus 340. In this embodiment, the axial retainer components, such as the aforementioned spline and groove arrangements, and seal components, such as an O-ring, are not shown. However, the pipe joint 28 in this embodiment can include such components and features. In this embodiment, the pipe joint 28 has two pipes 324a and 324b. The first pipe 324a has a second end or belled end 332 and the second pipe 324b has a first end or spigot 330 that is sized to fit within the belled end 332, as described above.

In this embodiment, the anti-rotation apparatus 340 includes a locking receptacle, a receiving receptacle, and a locking part, as in the embodiments described above. As shown in FIGS. 40 and 41, the receiving receptacle can be a groove formed in one of the joint parts, such as an outer surface 378 of the male or spigot end 330 of the second pipe 324b. The locking receptacle in this embodiment includes one or more notches 376 formed in a free or distal end of a second joint part, such as the belled end 332 of the first pipe 324a. The locking part in this embodiment is provided as a part of a stop piece 350, which in this embodiment is a band or strap 352 installed and seated in the groove. A boss or protrusion 354 is carried by the band 352 and extends radially outward relative to the outer surface 3878. The retaining part, i.e., the band 352 is captured in the groove and can be secured to the second pipe 324b by any known manner.

As shown in FIGS. 41 and 42, the pipes 324a and 324b can be assembled to one another. The boss 354 will contact either the distal free end of the pipe 324a or will seat in one of the notches 376, depending on rotational alignment. The pipes 324a and 324b can be rotated as needed so that the boss 354 seats in one of the notches 376. Once seated, the pipes 324a and 324b can be retained axially as noted above and the boss 354 in one of the notches 376 will prevent further rotation between the two pipes 324a and 324b.

In other embodiments, the notches 376 may vary in number, as can the number of bosses 354. To disassemble the pipe joint 28 in this example, the anti-rotation apparatus need not be removed or otherwise altered, once installed. Only the axial retention features need be removed or detached. The interference created by the anti-rotation apparatus 340 prevents relative rotation between the two pipes 324a and 324b. However, the two pipes 324a and 324b can be axially separated normally without interference from the anti-rotation apparatus 340 for joint disassembly once the axial retention mechanism is released.

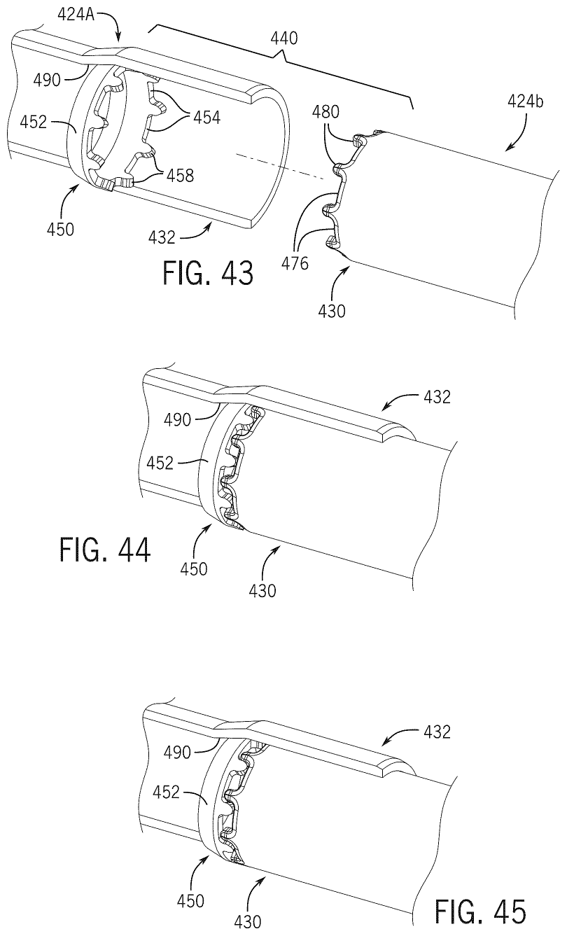

FIGS. 43-45 show simplified views of a pipe joint 28 that includes yet another embodiment of an anti-rotation apparatus 440. In this embodiment, the axial retainer components, such as the aforementioned spline and groove arrangements, and seal components, such as an O-ring, are not shown. However, the pipe joint 28 in this embodiment can include such components and features. In this embodiment, the pipe joint 28 has two pipes 424a and 424b. The first pipe 424a has a second end or belled end 432 and the second pipe 424b has a first end or spigot 430 that is sized to fit within the belled end 432, as described above.

In this embodiment, the anti-rotation apparatus 440 includes a locking receptacle, a receiving receptacle, and a locking part, as in the embodiments described above. As shown in FIGS. 43 and 44, the receiving receptacle can be the reduced diameter section 490 of the belled end 432 within the pipe 432a. The locking receptacle in this embodiment includes a plurality of notches 476 that are defined between teeth 480 formed in a free or distal end 488 of a second joint part, such as the male, spigot, or first end 432 of the second pipe 424b. The locking part in this embodiment is provided as a part of a stop piece 450, which in this embodiment is a ring 452 seated in the belled end 432 of the first pipe 424a. The stop piece 450 is seated and retained in place in the belled end at the stop 490. The ring 452 can have a tapered outer surface that matches the angle of the reduced diameter section in the belled end 432 to tightly fit in the pipe. Friction may be enough to rotationally secure the ring 452, but the ring 452 may include other features that engage the inner surface 474 of the wall of the pipe 424a to hold the stop piece 450 in place or the ring 452 can be held in place using other known techniques. The ring 452 includes a plurality of notches 454 separated by teeth 458 on an edge that faces the opening of the belled end 432. The teeth 458 and notches 454 can define the locking part of the stop piece 450 in this embodiment.

As shown in FIGS. 44 and 45, the pipes 424a and 424b can be assembled to one another. The teeth 480 on the second pipe 424b will contact either the distal free end of the teeth 458 of the stop piece 450 or will seat in the notches 454 on the stop piece 450, depending on rotational alignment. The pipes 424a and 424b can be rotated as needed so that the teeth of one pipe seat in the notches of the other pipe. Once seated and engaged in this manner, the pipes 424a and 424b can be retained axially as noted above and the corresponding teeth 480, 458 and notches 476, 454 will prevent further rotation between the two pipes 424a and 424b.

In other embodiments, the notches 476 and 454, as well as the teeth 480 and 458, may vary in number. To disassemble the pipe joint 28 in this example, the anti-rotation apparatus 440 need not be removed or otherwise altered, once installed. Only the axial retention features need be removed or detached. The interference created by the anti-rotation apparatus 440 prevents relative rotation between the two pipes 424a and 424b. However, the two pipes 424a and 424b can be axially separated normally without interference from the anti-rotation apparatus 440 for joint disassembly once the axial retention mechanism is released.

Other types of anti-rotation inserts, and solutions are also possible. Below, several are only briefly discussed. For example, splines may be utilized that retain pipe joint assemblies under both tension and rotation, i.e., that prevent or limit separation of and rotation between two pipes.

In one embodiment, a spline may be modified with an added feature on an existing pipe joint spline. The spline may include a protruding feature or features that interlock with spigot groove or notch feature when a pipe joint assembly joint is under tension, thus also preventing rotation. In this embodiment, the joint disassembly may be achieved by expanding the diameter of spline using an existing procedure.

In one embodiment, a pipe joint spline may be utilized to prevent lengthwise separation and have teeth to prevent rotation. In this embodiment, the spline prevents or restrains a pipe joint assembly under tension/compression and may have extrusions that also prevent relative rotation between the two pipes. In this example, the spline may be manually inserted into the bell and spigot grooves of the joint. Once the pipe joint assembly is under tension, the spline extrusions or teeth will interlock with indents or corresponding teeth in the spigot end groove. While the joint is not under tension, the spline and pipes grooves may be configured so that the spline may be pulled out for joint disassembly.

In one embodiment, a spline may have a shape to be similar to a tuning fork. The spline is flexible enough to be inserted into an opening in the belled end of one of the pipes of a pipe joint assembly with the spline legs straddling and extending around the joint. In this embodiment, the spigot end groove of the other pipe has a break that will interfere with the inserted spline, preventing relative rotation of the two pipes. The spline may be manually pulled out for joint disassembly.

In one embodiment, a double spline configuration may be utilized. In this embodiment, two splines are utilized to restrain the pipe joint assembly, similar to the previous spline fork embodiment. In this embodiment, the spigot end of the male pipe has a spline groove with breaks that will interfere with the two inserted splines, preventing relative rotation of the two pipes. The two splines may be manually pulled out for pipe joint disassembly.

In one embodiment, angled or slanted features may be utilized to prevent relative rotation of the two pipes of a pipe joint assembly. In one embodiment, the spline grooves of the two pipes may be formed or cut at an angle, i.e., are not directly circumferential but instead at least slightly helical relative to an axis of the pipe joint assembly. When the pipes are exposed to rotation, the angled spline will create a wedge that prevents relative rotation of the two pipes. The splines may be removed for joint disassembly.

In one embodiment, the pipes themselves may include an angled feature that creates a wedge preventing relative rotation of the two pipes. In this embodiment, the spigot end of the other pipe of the joint is cut at an angle. The internal diameter of the female or belled pipe includes an angled pipe stop. The angle of the end of the male spigot matches the geometry of the angled pipe stop when fully inserted into the female pipe. Again, the angle of the spigot end and the pipe stop will create a wedge that prevents relative rotation of the two pipes. The two pipes may be separated using normal procedures for disassembling the pipe joint in this example, as the anti-rotation solution does not include or require any separate parts or pieces.

In one embodiment, friction may be utilized to prevent relative rotation between two pipes of a pipe joint assembly. In one embodiment, a friction ring with teeth may be utilized. In this embodiment, an auxiliary ring with sharp protrusions is fastened to or seated on or in the female end or the belled pipe of the pipe joint. When male end of the spigot is inserted, the protrusions or “teeth” may be configured to make small cuts or dig into the OD surface of the spigot. The protrusions may be configured so that they do not halt or inhibit insertion or removal. The protrusions may also be configured so that the protrusions or teeth of the ring will grip the spigot material, preventing relative rotation of the two pipes. The spigot may be removed in a normal procedure for joint disassembly.

In one embodiment, an auxiliary ring with rollers can be utilized and be fastened or otherwise mounted to the female end of the belled pipe of the joint assembly. When the male end of the spigot is inserted, the rollers can be configured to freely rotate, allowing pipe insertion. The rollers can be configured so that friction between the rollers and the OD surface of the spigot will prevent relative rotation between the two pipes. The spigot may be removed normally for joint disassembly.

In one embodiment, a friction band may be utilized for creating friction between the two pipes in the circumferential direction. In this example, the friction band includes a ratchet feature and a rough surface finish and is inserted into the spline groove in the female or belled pipe. The friction band may be fully tightened around the pipe after the joint is assembled. The friction created by the friction band prevents relative rotation between the two pipes of the pipe joint assembly. The friction band can be unfastened and loosened for joint disassembly.

Other variations and modifications to the anti-rotation apparatus components are certainly possible within the spirit and scope of the present disclosure. The various recess and groove shapes, sizes, dimensions, and quantity can be changed. The receiving receptacle may include only a single hole, and the locking part may include only one stop piece. Other variations and modifications to the receiving and locking receptacles and the stop piece are also possible. Further, any pipe joint described herein can be configured at least in part on a pipe, a pipe coupler, or a component to which a pipe or coupler might be attached, such as a pump or motor or a component at a well head. Numerous features, aspects, characteristics, components, arrangements, and the like are disclosed for the embodiments sown and described herein. It should be understood that any one of the features, aspects, characteristics, components, arrangements, and the like may be utilized, alone or in any combination with any of the disclosed embodiments and with any other of the features, aspects, characteristics, components, arrangements, and the like.

Although certain anti-rotation apparatus and method embodiments, and pipe assembly and system embodiments, have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. An anti-rotation apparatus for a pipe joint, the apparatus comprising:
a stop piece having a body with a retaining portion and a locking part;
a first joint part and a second joint part coupled to one another and having an axis in a lengthwise direction of the pipe joint;
a locking receptacle provided in the first joint part; and
a receiving receptacle provided in the second joint part,
wherein the retaining portion of the body of the stop piece is retained in the receiving receptacle of the second joint part,
wherein the locking part protrudes in a direction of the locking receptacle, and
wherein, when the locking part and the locking receptacle are rotationally aligned, the locking part is disposed in the locking receptacle of the first joint part, relative rotation about the axis between the first joint part and the second joint part is prevented.

2. The anti-rotation apparatus of claim 1, wherein the first joint part is a spigot end of a first pipe, wherein the second joint part is a belled end of a second pipe, wherein the spigot end is disposed in the belled end, and wherein the axis is a center axis of the first and second pipes.

3. The anti-rotation apparatus of claim 1, wherein the receiving receptacle comprises a hole, a slot, or a keyhole through a wall of the second joint part.

4. The anti-rotation apparatus of claim 1, wherein the receiving receptacle comprises a threaded hole through a wall of the second joint part, wherein the stop piece includes a threaded stem configured to be screwed into the threaded hole, and wherein a free end of the threaded stem seats in the locking receptacle.

5. The anti-rotation apparatus of claim 4, wherein the receiving receptacle comprises a series of three of the threaded holes spaced apart circumferentially around the second joint part.

6. The anti-rotation apparatus of claim 1, wherein the locking receptacle comprises one or more locking grooves in an outer wall of the first joint part.

7. The anti-rotation apparatus of claim 1, wherein the locking receptacle comprises a plurality of locking grooves each having a finite length and extending in a circumferential direction around the first joint part, and wherein the finite length and a spacing between the plurality of locking grooves results in one of the plurality of locking grooves always being in rotational alignment with the receiving receptacle and the stop piece.

8. The anti-rotation apparatus of claim 1, wherein the body of the stop piece comprises:
a head;
a stem protruding from the head; and
mechanical threads formed on at least part of the stem,
wherein a free end of the stem opposite the head defines the locking part.

9. The anti-rotation apparatus of claim 1, wherein the locking part is installed in a radial direction relative to the axis from outside of the second joint part.

10. The anti-rotation apparatus of claim 1, wherein the body of the stop piece comprises:
a head;
a stem protruding from the head; and
a key disposed at a free end of the stem opposite the head,
wherein the key includes two bosses protruding in opposite directions from the free end of the stem, and
wherein the key defines the locking part.

11. The anti-rotation apparatus of claim 1, wherein the body of the stop piece comprises:
an elbow;
a pair of legs extending from the elbow at an acute angle relative to one another; and
a foot at a free end of each of the pair of legs, each foot protruding outward away from the other foot,
wherein the legs can be resiliently bent toward one another, and
wherein the feet and the free ends of the legs define the locking part.

12. A method of forming a pipe joint having an anti-rotation feature and an axis, the method comprising:
providing a first joint part having one or more locking receptacles formed in the first joint part;
inserting the first joint part into a second joint part; and
when no retaining receptacle on the second joint part is yet circumferentially aligned with any of the one or more locking receptacles, rotating the first joint part and the second joint part relative to one another until a retaining receptacle on the second joint part is circumferentially aligned with one of the one or more locking parts; and
moving the stop piece so that the locking part engages the one of the locking receptacles, thereby preventing relative rotation about the axis between the first joint part and the second joint part.

13. The method of claim 12, wherein the stop piece is partially inserted into the retaining receptacle before the step of inserting the first joint part.

14. The method of claim 12, wherein the step of moving the stop piece comprises installing the stop piece in the retaining receptacle.

15. A pipe joint assembly comprising:
a first pipe having a first pipe first end and a first pipe second end, the first pipe first end defining a spigot end of the first pipe;
a second pipe having a second pipe first end and a second pipe second end, the second pipe second end defining a belled end of the second pipe, the spigot end of the first pipe inserted into the belled end of the second pipe; and
an anti-rotation apparatus configured to prevent relative rotation between the first pipe and the second pipe,
wherein the anti-rotation apparatus includes a stop piece installed in a radial direction through a wall of the belled end of the second pipe, and
wherein a locking part of the stop piece is received in a locking receptacle in an outer surface of a wall of the spigot end of the first pipe.

16. The pipe joint assembly of claim 15, wherein the stop piece is installed through a hole, a keyhole, or a slot in the wall of the belled end of the second pipe.

17. The pipe joint assembly of claim 15, wherein the locking receptacle is a circular locking recess or a locking groove formed in the outer surface of the first pipe.

18. A drop pipe system comprising:
a pump configured to be installed below ground;
at least one power cord configured to extend from above ground level to the pump below ground level and to deliver power for operating the pump;
a pipe string including a plurality of pipes, the pipe string having one end connected to the pump and another end accessible near ground level;
a first pipe of the plurality of pipes having a first pipe first end and a first pipe second end;
a second pipe of the plurality of pipes having a second pipe first end and a second pipe second end, the first pipe first end connected to the second pipe second end to form a pipe joint; and
an anti-rotation apparatus at the pipe joint configured to prevent relative rotation between the first pipe and the second pipe when the pump is operated,
wherein the anti-rotation apparatus includes a stop piece installed in a radial direction through a wall the pipe joint, and
wherein a locking part of the stop piece is received in a locking receptacle in an outer surface of another wall of the pipe joint.

19. The pipe joint system of claim 18, wherein the first pipe first end is a spigot end, wherein the second pipe second end is a belled end, and wherein the spigot end of the first pipe is directly received within the belled end of the second pipe.
